(19) United States
(12) Patent Application Publication
(10) Pub. No.: US 2025/0070435 A1
(43) Pub. Date: Feb. 27, 2025

(54) ELECTROLYTE MANAGEMENT FOR ELECTROCHEMICAL POWER STORAGE

(71) Applicant: FORM ENERGY, INC., Somerville, MA (US)

(72) Inventors: Danielle Cassidy SMITH, Cambridge, MA (US); Grant Harrison FRIESEN, Concord, CA (US); Nicholas MCKIBBEN, Oakland, CA (US); Angel Ruben RIVERIA, Watertown, MA (US); Jhalak Joshipura VASAVADA, San Ramon, CA (US)

(21) Appl. No.: 18/815,825

(22) Filed: Aug. 26, 2024

Related U.S. Application Data
(60) Provisional application No. 63/578,524, filed on Aug. 24, 2023.

(51) Int. Cl. H01M 50/609; H01M 10/48; H01M 12/08; H01M 50/673; H01M 50/691

(52) U.S. Cl. CPC H01M 50/609; H01M 10/484; H01M 12/08; H01M 50/673; H01M 50/691

(57) ABSTRACT

According to one aspect, a system for electrochemical power storage may include at least one instance of a battery module, each instance of the battery module including a battery enclosure and a metal-air battery, the metal-air battery disposed in the battery enclosure; a reservoir including a volume of a liquid electrolyte; a supply conduit in fluid communication between the reservoir and the battery enclosure; a pump actuatable to move the liquid electrolyte from the reservoir into the battery enclosure via the supply conduit; and a return conduit in fluid communication between the battery enclosure and the reservoir, the liquid electrolyte movable from the battery enclosure to the reservoir, via the return conduit, with the metal-air battery immersed in the liquid electrolyte in the battery enclosure.

### CROSS-REFERENCE TO RELATED APPLICATIONS

This application claims the benefit of priority to U.S. Provisional Patent Application 63/578,524, filed Aug. 24, 2023, the entire contents of which are hereby incorporated herein by reference.

### BACKGROUND

Energy storage technologies are playing an increasingly important role in electric power grids. At a most basic level, these energy storage assets provide smoothing for better matching generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

Electrochemical systems with iron-based negative electrodes are attractive options for electrochemical energy storage. However, there exists a need to improve the design and composition of electrochemical systems having iron-based materials, such as iron-based negative electrodes, to enhance the performance of such systems.

### SUMMARY

Systems, methods, and devices of the various embodiments may include configurations for power systems. Systems and methods of the various embodiments may provide configurations for components of battery systems. Systems and methods of the various embodiments may provide metal-air battery storage systems including electrolyte management systems.

According to one aspect, a system for electrochemical power storage may include at least one instance of a battery module, each instance of the battery module including a battery enclosure and a metal-air battery, the metal-air battery disposed in the battery enclosure; a reservoir including a volume of a liquid electrolyte; a supply conduit in fluid communication between the reservoir and the battery enclosure; a pump actuatable to move the liquid electrolyte from the reservoir into the battery enclosure via the supply conduit; and a return conduit in fluid communication between the battery enclosure and the reservoir, the liquid electrolyte movable from the battery enclosure to the reservoir, via the return conduit, with the metal-air battery immersed in the liquid electrolyte in the battery enclosure.

In some implementations, each instance of the metal-air battery may include a metal electrode, and the air electrode, and a vessel, the metal electrode and the air electrode are immersed in the liquid electrolyte in the vessel, and a headspace region is defined between the battery enclosure and the liquid electrolyte in the vessel in each instance of the battery module. As an example, an excess amount of the liquid electrolyte may passively drain from the headspace region to the reservoir via the return conduit. Further, or instead, the return conduit may be angled between the battery enclosure and the reservoir such that gravity forces the liquid electrolyte through the return conduit to the reservoir. In some instances, an outlet section of the supply conduit may be coupled to a bottom portion of the vessel. In certain instances, the system may further include a controller and a sensor, the sensor arranged to detect overflow of the liquid electrolyte from the vessel, the controller communicatively coupled to the sensor and the pump, and the controller configured to receive, from the sensor, a signal indicative of the liquid electrolyte overflowing the vessel and to control actuation of the pump, based on the signal from the sensor, such that the pump fills the vessel with the electrolyte until the liquid electrolyte overflows the vessel, enters the return conduit, and returns to the reservoir.

In some implementations, each instance of the battery module further includes a float valve disposed in the battery enclosure, and the float valve is actuatable, according to a level of the liquid electrolyte in the battery enclosure, to control a flow of water from a water source into the respective instance of the battery enclosure.

In certain implementations, the system may further include an inlet valve actuatable to control a flow of water from a water source into the volume of the electrolyte in the reservoir. In some instances, the system may further include a level sensor arranged to detect a filling level of the volume of the liquid electrolyte in the reservoir; and a controller communicatively coupled to the level sensor and the inlet valve, the controller configured to receive, from the level sensor, a signal indicative of the filling level of the volume of the liquid electrolyte in the reservoir and to actuate the inlet valve to control the flow of water from the water source into the volume of the liquid electrolyte in the reservoir such that the filling level of the volume of the liquid electrolyte in the reservoir is maintained between a maximum and minimum filling level.

In some implementations, the system may further include a vent conduit in fluid communication with the supply conduit, wherein gas is releasable from the supply conduit via the vent conduit.

In certain implementations, the system may further include a filter in fluid communication with the supply conduit, wherein precipitants from the liquid electrolyte moving through the supply conduit are removable by the filter.

In some implementations, in each instance of the battery module, the metal-air battery may include an iron-air type battery cell, zinc-air type battery cell, a lithium-air battery cell, or a combination thereof.

In some implementations, the at least one instance of the battery module may include a plurality of instances of the battery module, the supply conduit comprises a supply manifold in fluid communication, in parallel, with the reservoir and each instance of the battery enclosure, and the return conduit includes a return manifold in fluid communication, in parallel, with the reservoir and each instance of the battery enclosure. In some instances, the system may further include a controller communicatively coupled to the pump, wherein the controller is configured to actuate the pump to move the liquid electrolyte through the supply manifold until the respective vessel of each of the plurality of instances of the battery modules is filled with the liquid electrolyte to a predetermined level. In some instances, an excess amount of the liquid electrolyte may be drainable from the respective battery enclosure of each one of the plurality of instances of the battery module via the return manifold.

According to another aspect, a system for electrochemical power storage may include a battery module including a battery enclosure and a metal-air battery, the metal-air battery disposed in the battery enclosure; a reservoir comprising a volume of a liquid electrolyte; a transfer conduit, the reservoir in fluid communication with the battery enclosure via the transfer conduit; and a plunger disposed in the reservoir and movable in the reservoir to control a flow of the liquid electrolyte between the battery enclosure and the reservoir via the transfer conduit.

In some instances, the plunger may be movable between a raised position and a lowered position to control the flow of the liquid electrolyte between the battery enclosure and the reservoir via the transfer conduit, the plunger in the raised position moves an excess amount of the liquid electrolyte from the battery enclosure, through the transfer conduit, and into the reservoir, and the plunger in the lowered position forces the liquid electrolyte in the reservoir through the transfer conduit and into the battery enclosure.

In certain implementations, the reservoir may define an opening, the reservoir is in fluid communication with the transfer conduit through the opening, the plunger in the raised position is disposed above the opening such that an excess amount of the liquid electrolyte flows in a direction from the battery module and into the reservoir via the transfer conduit, and the plunger in the lowered position is disposed below the opening such that the liquid electrolyte in the reservoir is forced out of the opening, through the transfer conduit, and into the battery module.

In some implementations, the system may further include an inlet valve actuatable to control a flow of water from a water source into the volume of the liquid electrolyte in the reservoir.

In certain implementations, when the plunger is in the raised position, water received from the water source may be collected below the plunger, and when the plunger is in the lowered position, the water and the liquid electrolyte is forced from the reservoir and into the battery enclosure.

According to yet another aspect, a system for electrochemical power storage may include a plurality of instances of a battery module, each instance of the battery module including a battery enclosure and a metal-air battery, the metal-air battery disposed in the battery enclosure; a water manifold fluidly in fluid communication with each instance of the battery enclosure; and a plurality of instances of a float valve, each instance of the float valve disposed in a respective instance of the battery enclosure, and each instance of the float valve actuatable, according to a level of a liquid electrolyte in the battery enclosure, to control a flow of water from a water source, through the water manifold, and into the respective instance of the battery enclosure.

### DESCRIPTION OF THE DRAWINGS

FIG. 1 is a system block diagram of a power generation system including a power generation source, a short duration energy storage (SDES) system, and a long duration energy storage (LODES) system, shown located in the same plant.

FIG. 2 is a system block diagram of a power generation system including a power generation source, a short duration energy storage (SDES) system, and a long duration energy storage (LODES) system, shown separated in different plants.

FIG. 3 is a schematic representation of an electrochemical cell.

FIG. 4A is a schematic representation of an enclosure of an electrochemical cell.

FIG. 4B is an exploded view of the enclosure of FIG. 4A.

FIGS. 5A-5D are schematic diagrams of example module configurations including multiple electrochemical cells

FIGS. 6A-6C are perspective views of portions of an enclosure for a battery module.

FIGS. 7A-7C are schematic representations of example configurations of enclosures for battery modules.

FIGS. 8A-8E are schematic representations of an example layout of battery modules within an enclosure.

FIGS. 9A-9F are schematic representations of an example layout of battery modules within an enclosure.

FIGS. 10A-10E are schematic representations of an example layout of battery modules within an enclosure.

FIG. 11 is a schematic representation of an electrolyte management system for a metal-air battery module, the electrolyte management system including a reservoir storing a liquid electrolyte with a gaseous headspace above the liquid electrolyte in the reservoir.

FIGS. 12A-12E are schematic representations of a time-varying sequence of operation of the electrolyte management system of FIG. 11.

FIG. 13 is a schematic representation of an electrolyte management system for a metal-air battery module, the electrolyte management system including a plunger and a transfer conduit to fluidically connect an opening of a reservoir to each battery enclosure.

FIGS. 14A-14E are schematic representations of a time-varying sequence of operations of the electrolyte management system of FIG. 13.

FIG. 15 is a schematic representation of an electrolyte management system for a metal-air battery module, the electrolyte management system including a float valve.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but to enable a person skilled in the art to make and use this disclosure. Unless otherwise noted, the accompanying drawings are not drawn to scale.

As used herein, unless otherwise specified, the recitation of values herein is merely intended to serve as a shorthand method of referring individually to each separate value falling within the range. Unless otherwise indicated, herein, each individual value within a range is incorporated into the specification as if it were individually recited herein.

The various embodiments of systems, equipment, techniques, methods, activities and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this disclosure. Thus, the scope of protection afforded the present inventions should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems.

Various embodiments may include devices, systems, and/or methods for use in long-duration and ultra-long-duration, low-cost, energy storage, including in multi-day energy storage. Herein, “long duration” and “ultra-long duration” and similar such terms, unless expressly stated otherwise, should be given their broadest possible meaning and may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration,” “energy storage cells” including “electrochemical cells,” and similar such terms, unless expressly stated otherwise, should be given their broadest possible interpretation; and include electrochemical cells that store energy over time spans of days, weeks, or seasons, such as electrochemical cells sometimes referred to as multi-day energy storage (MDS) cells. As a matter of definition, the term “duration” means the ratio of rated energy to rated power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments shall be understood to encompass other combinations and permutations of storage technologies that may be substituted for the example solar+Li-ion+Fe-air discussions herein. For example, various metal-air storage technologies may be used as batteries in the various embodiments, such as zinc-air, lithium-air, sodium-air, etc.

As used herein, the term “module” may refer to a string of unit cells (e.g., a string of batteries). Multiple modules (or multiple units or cells) may be connected together to form battery strings.

Unless otherwise expressed or made clear from the context, the recitation of any element in the singular shall be understood to be intended to encompass embodiments including one or more such elements and the separate recitation of “one or more” is generally omitted for the sake of clarity and readability. Thus, for example, recitation of a LODES system 104 shall be understood to be inclusive of one or more LODES systems, etc.

In the description that follows, all materials (e.g., solids, liquids, gases, or combinations thereof) may flow through conduits (e.g., pipes and/or manifolds) unless specified otherwise or made clear from the context.

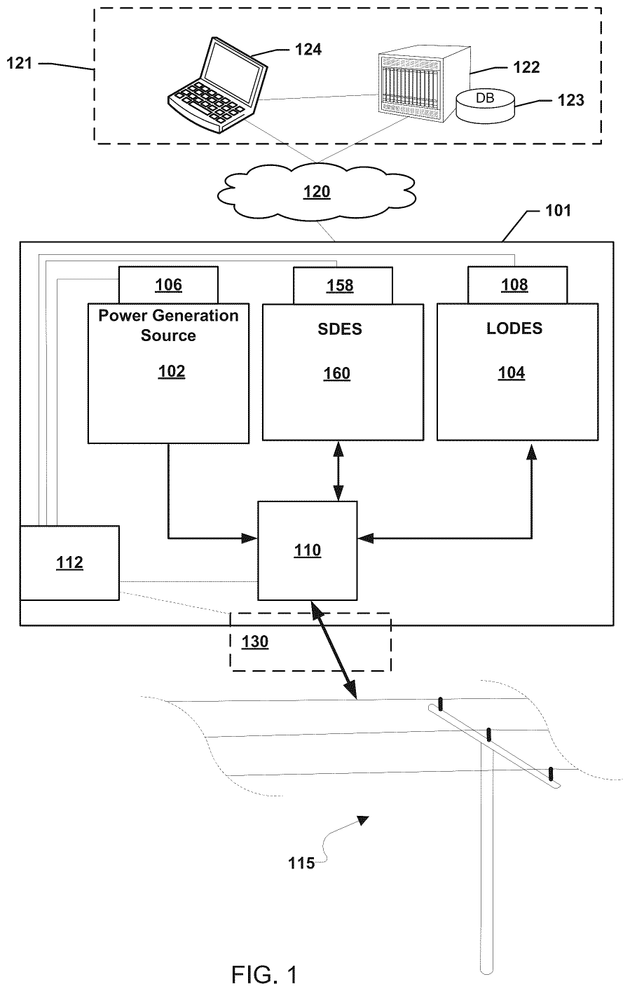

FIG. 1 is a system block diagram of a power generation system 101 (also referred to as a power system) according to various embodiments. The power generation system 101 may be a power plant including one or more power generation sources 102, one or more LODES 104 (e.g., multi-day energy storage (MDS) systems, also referred to herein as a system for electrochemical power storage), and one or more SDES 160. As examples, the power generation sources 102 may be renewable power generation sources, non-renewable power generation sources, combinations of renewable and non-renewable power generation sources, etc. Examples of power generation sources 102 may include wind generators, solar generators, geothermal generators, nuclear generators, etc. The LODES 104 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Al, AlCl3, Fe, FeOx(OH)y, NaxSy, SiOx(OH)y, AlOx(OH)y, metal-air, and/or any suitable type of battery chemistry. The SDES 160 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation sources 102 may be controlled by one or more control systems 106. The control systems 106 may include motors, pumps, fans, switches, relays, or any other type devices that may serve to control the generation of electricity by the power generation sources 102. In various embodiments, the operation of the LODES 104 may be controlled by one or more control systems 108. The control systems 108 may include motors, pumps, fans, switches, relays, or any other type devices that may serve to control the discharge and/or storage of electricity by the LODES system. In various embodiments, the operation of the SDES 160 may be controlled by one or more control systems 158. The control systems 158 may include motors, pumps, fans, switches, relays, or any other type devices that may serve to control the discharge and/or storage of electricity by the SDES system. The control systems 106, 108, 158 may all be connected to a plant controller 112. The plant controller 112 may monitor the overall operation of the power generation system 101 and generate and send control signals to the control systems 106, 108, 158 to control the operations of the power generation sources 102, LODES 104, and/or SDES 160.

In the power generation system 101, the power generation sources 102, the LODES 104, and the SDES 160 may all be connected to one or more power control devices 110. The power control devices 110 may be connected to a power grid 115 or other transmission infrastructure. The power control devices 110 may include switches, inverters (e.g., AC to DC inverters, DC to AC inverters, etc.), relays, power electronics, and any other type devices that may serve to control the flow of electricity from to/from one or more of the power generation sources 102, the LODES 104, the SDES 160, and/or the power grid 115. Additionally, the power generation system 101 may include transmission facilities 130 connecting the power generation, transmission, and power generation system 101 to the power grid 115. As an example, the transmission facilities 130 may connect between the power control devices 110 and the power grid 115 to enable electricity to flow between the power generation system 101 and the power grid 115. Transmission facilities 130 may include transmission lines, distribution lines, power cables, switches, relays, transformers, and any other type devices that may serve to support the flow of electricity between the power generation system 101 and the power grid 115. The power control devices 110 and/or transmission facilities 130 may be connected to the plant controller 112. The plant controller 112 may monitor and control the operations of the power control devices 110 and/or transmission facilities 130, such as via various control signals. As examples, the plant controller 112 may control the power control devices 110 and/or transmission facilities 130 to provide electricity from the power generation sources 102 to the power grid 115, to provide electricity from the LODES 104 to the power grid 115, to provide electricity from both the power generation sources 102 and the LODES 104 to the power grid 115, to provide electricity from the power generation sources 102 to the LODES 104, to provide electricity from the power grid 115 to the LODES 104, to provide electricity from the SDES 160 to the power grid 115, to provide electricity from both the power generation sources 102 and the SDES 160 to the power grid 115, to provide electricity from the power generation sources 102 to the SDES 160, to provide electricity from the power grid 115 to the SDES 160, to provide electricity from the SDES 160 and the LODES 104 to the power grid 115, and/or to provide electricity from the power generation sources 102, the SDES 160, and the LODES 104 to the power grid 115. In various embodiments, the power generation source 102 may selectively charge the LODES 104 and/or SDES 160 and the LODES 104 and/or SDES 160 may selectively discharge to the power grid 115. In this manner, energy (e.g., renewable energy, non-renewable energy, etc.) generated by the power generation source 102 may be output to the power grid 115 sometime after generation from the LODES 104 and/or SDES 160.

In various embodiments, plant controller 112 may be in communication with a network 120 (e.g., 3G network, 4G network, 5G network, core network, Internet, combinations of the same, etc.). Using the connections to the network 120, the plant controller 112 may exchange data with the network 120 as well as devices connected to the network 120, such as a plant management system 121 or any other device connected to the network 120. The plant management system 121 may include one or more computing devices, such as computing device 124 and server 122. The computing device 124 and server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface enabling a user of the plant management system 121 to define inputs to the plant management system 121 and/or power generation system 101, receive indications associated with the plant management system 121 and/or power generation system 101, and otherwise control the operation of the plant management system 121 and/or the power generation system 101.

While illustrated as two separate devices, 124 and 122, the functionality of the computing device 124 and server 122 described herein may be combined into a single computing device or may split among more than two devices. Additionally, while illustrated as a dedicated part of the plant management system 121, the functionality of the computing device 124 and server 122 may be in whole, or in part, offloaded to a remote computing device, such as a cloud-based computing system. While illustrated as in communication with a single instance of the power generation system 101, the plant management system 121 may be in communication with multiple power generation systems.

While illustrated as being geographically located together in FIG. 1, the power generation sources 102, the LODES 104, and the SDES 160 may be separated from one another in various embodiments. For example, the LODES 104 may be downstream of a transmission constraint, such as downstream of a portion of the power grid 115, etc., from the power generation source 102 and SDES 160. In this manner, the over build of underutilized transmission infrastructure may be avoided by situating the LODES 104 downstream of a transmission constraint, charging the LODES 104 at times of available capacity and discharging the LODES 104 at times of transmission shortage. The LODES 104 may also arbitrate electricity according to prevailing market prices to reduce the final cost of electricity to consumers.

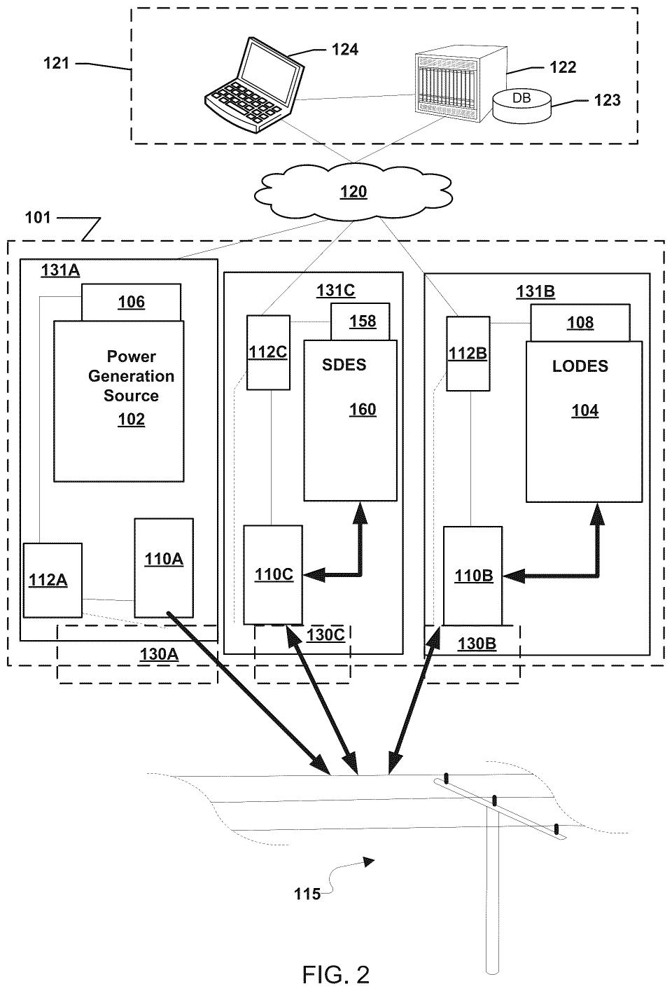

FIG. 2 illustrates an example of a power generation system 101 in which the power generation sources 102 and the bulk energy storage systems, such as the LODES 104 and/or the SDES 160, may be separated from one another according to various embodiments. With reference to FIGS. 1-2, FIG. 2 is similar to FIG. 1, except the power generation source 102, LODES 104, and SDES 160 may be separated in different plants 131A, 131B 131C, respectively. While the plants 131A, 131B, 131C may be separated, the power generation system 101 and the plant management system 121 may operate as described above with reference to FIG. 1. The plants 131A, 131B, and 131C may be co-located or may be geographically separated from one another. The plants 131A, 131B, and 131C may connect to the power grid 115 at different places. For example, the plant 131A may be connected to the grid upstream of where the plant 131B is connected. The plant 131A associated with the power generation sources 102 may include its own respective plant controller 112A and its own respective power control devices 110A and/or transmission facilities 130A. The power control devices 110A and/or transmission facilities 130A may be connected to the plant controller 112A. The plant controller 112A may monitor and control the operations of the power control devices 110A and/or transmission facilities 130A, such as via various control signals. As examples, the plant controller 112A may control the power control devices 110A and/or transmission facilities 130A to provide electricity from the power generation sources 102 to the power grid 115, etc.

The plant 131B associated with the LODES 104 may include its own respective plant controller 112B and its own respective power control devices 110B and/or transmission facilities 130B. The power control devices 110B and/or transmission facilities 130B may be connected to the plant controller 112B. The plant controller 112B may monitor and control the operations of the power control devices 110B and/or transmission facilities 130B, such as via various control signals. As examples, the plant controller 112B may control the power control devices 110B and/or transmission facilities 130B to provide electricity from the LODES 104 to the power grid 115 and/or to provide electricity from the power grid 115 to the LODES 104, etc. The plant 131C associated with the SDES 160 may include its own respective plant controller 112C and its own respective power control devices 110C and/or transmission facilities 130C. The power control devices 110C and/or transmission facilities 130C may be connected to the plant controller 112C. The plant controller 112C may monitor and control the operations of the power control devices 110C and/or transmission facilities 130C, such as via various control signals. As examples, the plant controller 112C may control the power control devices 110C and/or transmission facilities 130C to provide electricity from the SDES 160 to the power grid 115 and/or to provide electricity from the power grid 115 to the SDES 160, etc.

The respective plant controllers 112A, 112B, 112C and respective transmission facilities 130A, 130B, 130C may be similar to the plant controller 112 and transmission facilities 130 described with reference to FIG. 1.

In various embodiments, the respective plant controllers 112A, 112B, 112C may be in communication with the network 120. Using the connections to the network 120, the respective plant controllers 112A, 112B, 112C may exchange data with the network 120 as well as devices connected to the network 120, such as a plant management system 121, each other, or any other device connected to the network 120. In various embodiments, the operation of the plant controllers 112A, 112B, 112C may be monitored by the plant management system 121 and the operation of the plant controllers 112A, 112B, 112C, and thereby the power generation system 101, may be controlled by the plant management system 121.

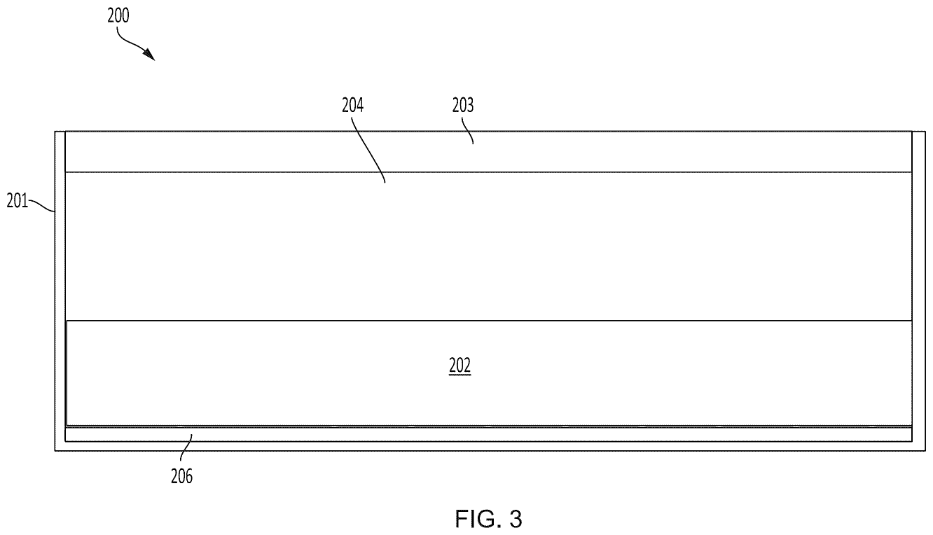

FIG. 3 is a schematic view of a metal-air battery 200, according to various embodiments of the present disclosure. With reference to FIGS. 1-3, the metal-air battery 200 may be one type of battery that may be used in a LODES 104 in various embodiments. Referring to FIG. 3, the metal-air battery 200 includes a vessel 201 in which an air electrode 203 (e.g., a cathode), a metal electrode 202 (e.g., an anode), a liquid electrolyte 204, and a current collector 206 are disposed. The metal electrode 202 may be a metal electrode, such as an iron electrode, lithium electrode, zinc electrode, or other type suitable metal. The liquid electrolyte 204 may separate the air electrode 203 from the metal electrode 202. As examples, the metal-air battery 200 may be a metal-air type battery, such as an iron-air battery, lithium-air battery, zinc-air battery, etc. While various examples are discussed with reference to metal-air batteries, other type batteries may be substituted in the various examples and used in the various embodiments. The metal-air battery 200 may represent a single cell or unit, and multiple instances of the metal-air battery 200 (or multiple units or cells) may be connected together to form battery strings (also referred to as modules).

In various embodiments, the metal electrode 202 may be solid and the liquid electrolyte 204 may be excluded from the anode. In various embodiments the metal electrode 202 may be porous and the liquid electrolyte 204 may be interspersed geometrically with the metal electrode 202, creating a greater interfacial surface area for reaction. In various embodiments, the air electrode 203 may be porous and the electrolyte interspersed geometrically with the air electrode 203, creating a greater interfacial surface area for reaction. In various embodiments, the air electrode 203 may be positioned at the interface of the electrolyte and a gaseous headspace (not shown). In various embodiments, the gaseous headspace may be sealed in a housing. In various other embodiments, the housing may be unsealed and the gaseous headspace may be an open system which can freely exchange mass with the environment.

The metal electrode 202 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. The metal electrode 202 may be referred to herein as the negative electrode or the anode.

In certain embodiments, the battery may be rechargeable and the metal electrode may undergo a reduction reaction when the battery is charged. The metal electrode 202 may be a solid, including a dense or porous solid, or a mesh or foam, or a particle or collection of particles, or may be a slurry, ink, suspension, or paste deposited within the housing. In various embodiments, the metal electrode 202 composition may be selected such that the metal electrode 202 and the volume of liquid electrolyte 204 may not mix together. For example, the metal electrode 202 may be a metal electrode that may be a bulk solid. As another example, the metal electrode 202 may be a collection of particles, such as small or bulky particles, within a suspension that are not buoyant enough to escape the suspension into the electrolyte. As another example, the metal electrode 202 may be formed from particles that are not buoyant in the electrolyte.

The air electrode 203 which may also be referred to as an air electrode, may support the reaction with oxygen on the positive electrode. The air electrode 203 may be a so-called gas diffusion electrode (GDE) in which the cathode is a solid, and it sits at the interface of a gas headspace and the liquid electrolyte 204. During the discharge process, the air electrode 203 supports the reduction of oxygen from the gaseous headspace, the so-called Oxygen Reduction Reaction (ORR). In certain embodiments, the metal-air battery 200 is rechargeable and the reverse reaction occurs, in which the air electrode 203 supports the evolution of oxygen from the battery, the so-called Oxygen Evolution Reaction (OER). The OER and ORR reactions are commonly known to those skilled in the art.

In various embodiments, the liquid electrolyte 204 is a liquid. In certain embodiments, the liquid electrolyte 204 may be an aqueous solution, a non-aqueous solution, or a combination thereof. In various embodiments the liquid electrolyte 204 is an aqueous solution which may be acidic (low-pH), neutral (intermediate pH), or basic (high pH; also called alkaline or caustic). In certain embodiments the liquid electrolyte 204 may comprise an electropositive element, such as Li, K, Na, or combinations thereof. In some embodiments, the liquid electrolyte may be basic, namely with a pH greater than 7. In some embodiments the pH of the electrolyte is greater than 10, and in other embodiments, greater than 12. For example, the liquid electrolyte 204 may comprise a 6M (mol/liter) concentration of potassium hydroxide (KOH). In certain embodiments, the liquid electrolyte 204 may comprise a combination of ingredients such as 5.5M potassium hydroxide (KOH) and 0.5M lithium hydroxide (LiOH). In certain embodiments the electrolyte 140 may comprise a 6M (mol/liter) concentration of sodium hydroxide (NaOH). In certain embodiments the electrolyte 140 may comprise a 5M (mol/liter) concentration of sodium hydroxide (NaOH) and IM potassium hydroxide (KOH).

In certain embodiments, the metal-air battery 200 discharges by reducing oxygen (O2) typically sourced from air. This requires a triple-phase contact between gaseous oxygen, an electronically active conductor which supplies the electrons for the reduction reaction, and an electrolyte 140 which contains the product of the reduction step. For example, in certain embodiments involving an aqueous alkaline electrolyte, oxygen from air is reduced to hydroxide ions through the half-reaction O2+2H2O+4e-→4OH—. Thus, oxygen delivery to metal-air cells requires gas handling and maintenance of triple-phase points. In certain embodiments, called “normal air-breathing” configurations, the air electrode 203 may be mechanically positioned at the gas-liquid interface to promote and maintain triple-phase boundaries. The air electrode 203 may be positioned vertically or horizontally, or at any intermediate angle with respect to gravity, and maintain a “normal air-breathing” configuration. In these “normal air-breathing” configurations, the gas phase is at atmospheric pressure (i.e. it is unpressurized beyond the action of gravity).

The configuration of the metal-air battery 200 in FIG. 3 is merely an example of one electrochemical cell configuration according to various embodiments and is not intended to be limiting. Other configurations, such as electrochemical cells with different type vessels and/or without the vessel 201, electrochemical cells with different type air electrodes and/or without the air electrode 203, electrochemical cells with different type current collectors and/or without the current collector 206, electrochemical cells with different type negative electrodes and/or without the metal electrode 202, and/or electrochemical cells with different type electrolytes and/or electrochemical cells without liquid electrolyte 204 may be substituted for the example configuration of the metal-air battery 200 shown in FIG. 3 and other configurations are in accordance with the various embodiments.

In various embodiments, the vessel 201 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments the vessel 201 and/or housing for the metal-air battery 200 may be made from a metal such as nickel, steel, anodized aluminum, nickel coated steel, nickel coated aluminum or other metal.

In various embodiments, a battery (e.g., the metal-air battery 200) may include three electrodes—an anode (e.g., the metal electrode 202) and a dual cathode (e.g., the air electrode 203 constituted in two parts, such as a first cathode, and a second cathode). The electrodes may have finite useful lifetimes, and may be mechanically replaceable. For example, the anode may be replaced seasonally. The first cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion may be a microporous layer (MPL) of polytetrafluorethylene (PTFE) and high surface area carbon while the first portion may be carbon fiber partially coated with PTFE. As another example, the second portion may be a MPL of PTFE and carbon black and the first portion may be PTFE of approximately 33% by weight. As a further example, the second portion may be an MPL of 23% by weight PTFE and 77% by weight carbon black and the first portion may be a low loading MPL. The anode may be an iron (Fe) electrode or an iron-alloy (Fe-alloy) electrode (e.g., FeAl, FeZn, FeMg, etc.). The second cathode may have a hydrophilic surface. The second cathode may have a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may be comprised of a number of cells connected in series and/or parallel in a shared electrolyte bath and contained in a housing.

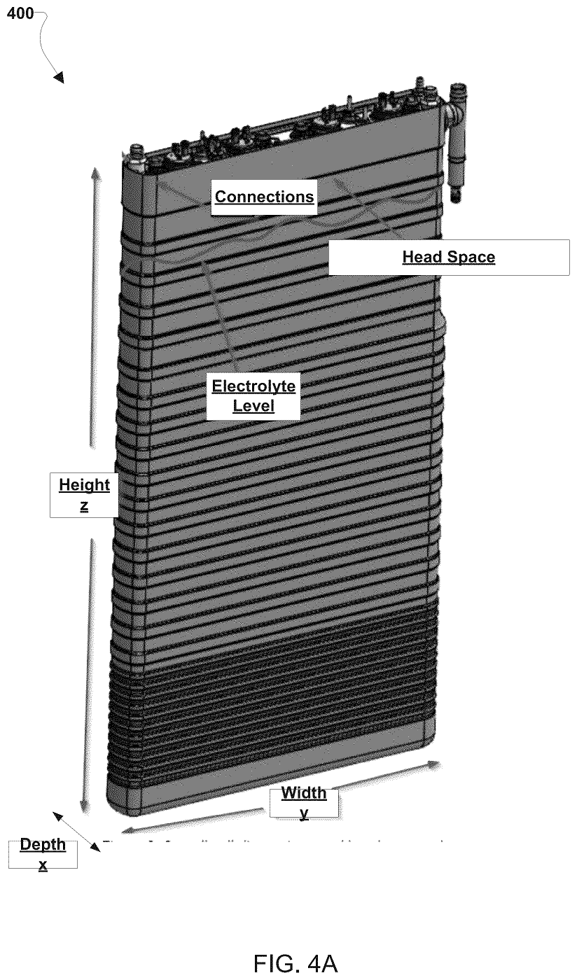

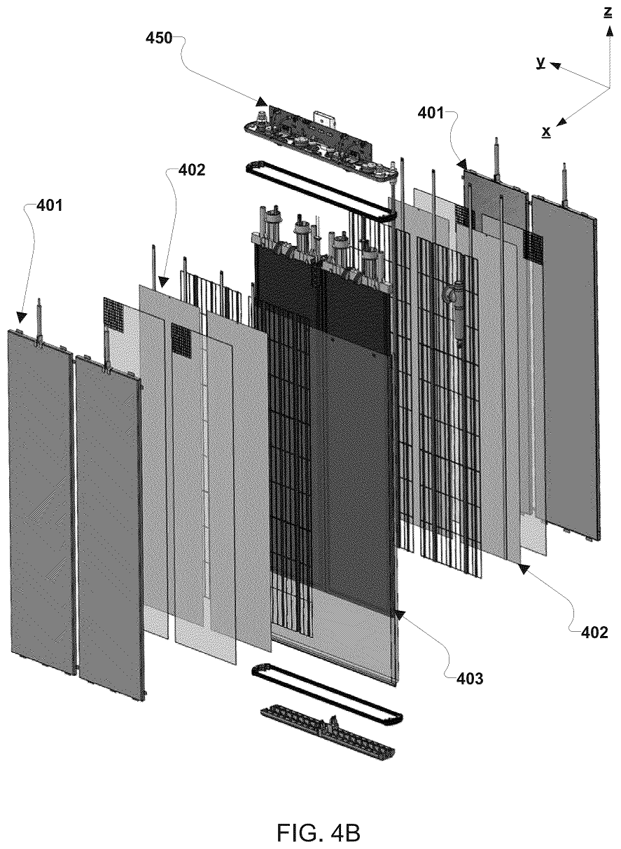

FIG. 4A is a schematic diagram of an example single electrochemical cell (or battery) including a battery enclosure 400 in accordance with various embodiments. With reference to FIGS. 1-4, the battery enclosure 400 may contain a battery, such as the metal-air battery 200, in accordance with various embodiments. In some implementations, the battery enclosure 400 may be the vessel, such as vessel 201, in which an air electrode (e.g., a cathode), such as air electrode 203, a negative electrode (e.g., an anode), such as the metal electrode 202, and an electrolyte, such as the liquid electrolyte 204, are disposed. The electrolyte, such as the liquid electrolyte 204, may rise to a given level within the battery enclosure 400 and a headspace between the top of the battery enclosure 400 and electrolyte level may be formed in the battery enclosure 400. The battery enclosure 400 may have a height (e.g., a z dimension), a width (e.g., a y dimension), and a depth (e.g., a x dimension). In one example, configuration, the height may be greater than the width and depth and the width may be greater than the depth such that the battery enclosure 400 is a generally rectangular cuboid. The battery enclosure 400 may include one or more various connections, such as electrical connections, electrolyte connections, gas connections (e.g., air connections), vents, etc. Via the connections, two or more electrochemical cells (or batteries) may be connected together, such as in series and/or in parallel, to form a module.

Each cell/battery enclosure, such as enclosure 400, in a module may be a self-contained unit supporting its own respective air electrode (e.g., air electrode 203), negative electrode (e.g., the metal electrode 202), and electrolyte (e.g., the liquid electrolyte 204) volume. The module structure may support the cell enclosures, such as enclosures 400, disposed within the module.

FIG. 4B is an exploded view diagram of portions of an inside of the example electrochemical cell (or battery) showing one example configuration of an electrochemical cell (or battery) in accordance with various embodiments. With reference to FIGS. 1-4B, the battery enclosure 400 may have within it various electrochemical cell (or battery) elements including one or more anode assemblies 401, such as one or more instances of the metal electrode 202, one or more cathode assemblies, such as an air electrode 203, and electrolyte, such as the liquid electrolyte 204. The configuration in FIG. 4B illustrates a two part cathode in which the cathode assembly includes an Oxygen Evolution Electrode (OEE) 402 and a separate gas diffusion electrode (GDE) 403. A battery configuration that includes at least one OEE 402 and at least one GDE 403 may be referred to as a multi-cathode battery cell. The OEE 402 may be disposed within the enclosure between an anode assembly 401 and the GDE 403. The GDE 403 may be disposed in the center of the battery enclosure 400 and an additional GDE 403 and anode assembly 401 pair may be in a mirror configuration on the opposite side of the GDE 403. Air may enter the battery enclosure 400 and pass into the center of the GDE 403. Thus, in an example configuration, within the battery enclosure 400, each electrochemical cell (or battery) may include opposite side anode assemblies 401 each with their own respective OEE 402 in board of the respective anode assemblies 401, with a central GDE 403 with air passage down the center between the two OEEs 402. However, such internal cell (or battery) structure is merely one example configuration of the cell (or battery) that may be within an example enclosure, such as enclosure 400, and is not intended to be limiting. Additionally, the battery enclosure 400 may include one or more cell electronics structures 450, such as a printed circuit board assembly (PCBA), circuitry housing, etc., supporting various electronic devices, such as controllers, sensors, switches, wiring buses, etc., that may control and/or manage operations of the multi-cathode battery cell.

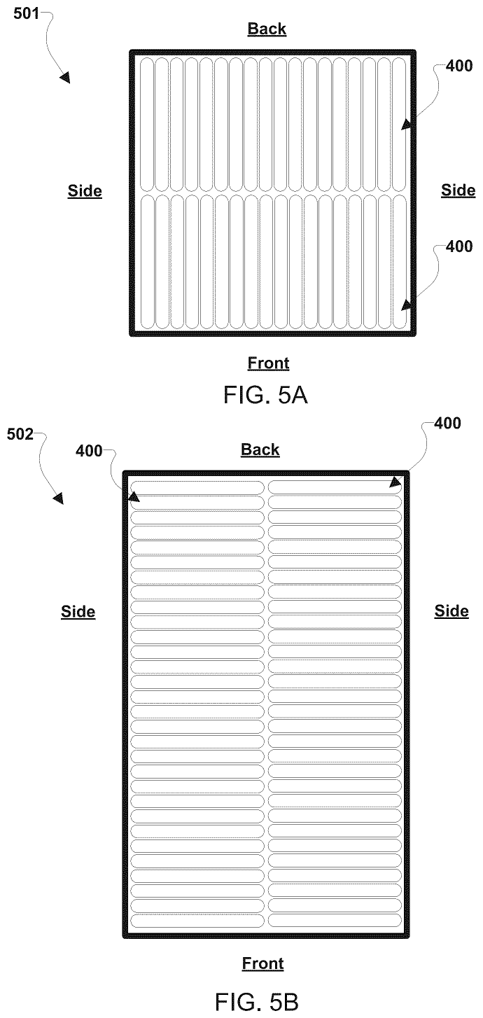

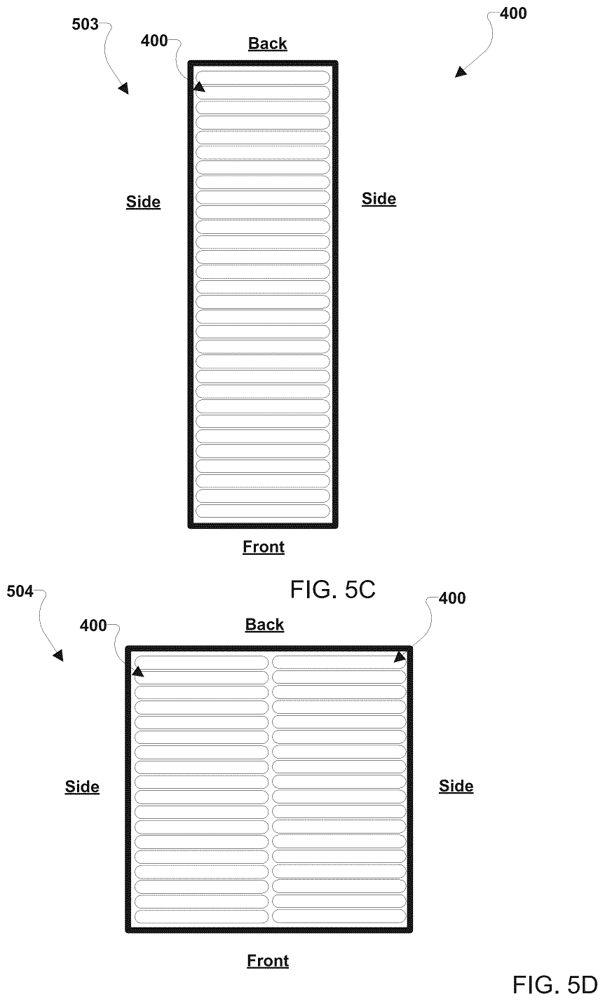

FIG. 5A is a schematic diagram of an example module 501 configuration including multiple instances of the enclosures 400 in accordance with various embodiments. With reference to FIGS. 1-5A, the module 501 is shown from an overhead view looking down the height (e.g., z dimension) of the enclosures 400. The module 501 configuration may be a generally cubic configuration with the front, back, and sides of the module 501 about the same lengths. In the module 501, two rows of the enclosures 400 may be arranged such that the widths of the enclosures 400 run parallel to the sides of the module 501 and the depths of the enclosures 400 run parallel to the front and back of the module 501. In the configuration of the module 501, the widths of the enclosures 400 may generally govern the length of the sides of the module 501 along with any spacing between the rows of enclosures 400 and spacing of the respective rows and the front and back of the module 501. The number instances of the enclosures 400 in each row and the depth of the enclosures 400 may generally govern the length of the front and back of the module 501 along with the spacing between the enclosures 400 in each row and the spacing of the respective rows and the sides of the module 501.

FIG. 5B is a schematic diagram of another example module 502 configuration including multiple instances of the enclosures 400 in accordance with various embodiments. With reference to FIGS. 1-5B, the module 502 is shown from an overhead view looking down the height (e.g., z dimension) of the enclosures 400. The module 502 configuration may be a generally rectangular configuration with the sides of the module 502 longer than the back and front of the module 502. In the module 502, two rows of the enclosures 400 may be arranged such that the widths of the enclosures 400 run parallel to the front and back of the module 502 and the depths of the enclosures 400 run parallel to the sides of the module 502. In the configuration of the module 502, the widths of the enclosures 400 may generally govern the length of the front and back of the module 502 along with any spacing between the rows of enclosures 400 and spacing of the respective rows and the sides of the module 502. The number of instances of the enclosures 400 in each row and the depth of the enclosures 400 may generally govern the length of the sides of the module 502 along with the spacing between the enclosures 400 in each row and the spacing of the respective rows and the front and back of the module 502.

FIG. 5C is a schematic diagram of another example module 503 configuration including multiple instances of the enclosures 400 in accordance with various embodiments. With reference to FIGS. 1-5C, the module 503 is shown from an overhead view looking down the height (e.g., z dimension) of the enclosures 400. The module 503 configuration may be a generally rectangular configuration with the sides of the module 503 longer than the back and front of the module 503. In the module 503, a single row of the enclosures 400 may be arranged such that the widths of the enclosures 400 run parallel to the front and back of the module 503 and the depths of the enclosures 400 run parallel to the sides of the module 502. In the configuration of the module 503, the widths of the single row of the enclosures 400 may generally govern the length of the front and back of the module 503 along with any spacing between the sides of the module 503. The number of instances of the enclosures 400 in the row and the depth of the enclosures 400 may generally govern the length of the sides of the module 503 along with the spacing between the enclosures 400 in the row and the spacing between the front and back of the module 503.

FIG. 5D is a schematic diagram of another example module 504 configuration including multiple instances of the enclosures 400 in accordance with various embodiments. With reference to FIGS. 1-5D, the module 504 is shown from an overhead view looking down the height (e.g., z dimension) of the enclosures 400. The module 504 configuration may be a generally cubic configuration with the front, back, and sides of the module 501 about the same lengths. In the module 504, two rows of the enclosures 400 may be arranged such that the widths of the enclosures 400 run parallel to the front and back of the module 504 and the depths of the enclosures 400 run parallel to the sides of the module 502. In the configuration of the module 504, the widths of the two instances of the enclosures 400 may generally govern the length of the front and back of the module 504 along with any spacing between the rows of enclosures 400 and spacing of the respective rows and the sides of the module 504. The number of instances of the enclosures 400 in each row and the depth of the enclosures 400 may generally govern the length of the sides of the module 504 along with the spacing between the enclosures 400 in each row and the spacing of the respective rows and the front and back of the module 504.

The configuration of the modules 501-504 in FIGS. 5A-5D are merely examples modules including multiple electrochemical cell configurations according to various embodiments and are not intended to be limiting. Other configurations, such modules with more or less rows, modules with no-linear configurations, modules with more or less cells, etc., may be substituted for the example configuration of the modules 501-504 and other configurations are in accordance with the various embodiments.

In various embodiments, battery modules having strings of cells therein, such as modules 501-504, may be enclosed in a module enclosure. A module enclosure may house one or more modules, modules having strings of cells therein, such as modules 501-504.

Modules, such as modules 501-504, deployed in the field may need protection from the elements, such as: wind, dust, snow, rain, seismic activity, etc. The modules, such as modules 501-504, may also need to be secured to the ground to prevent movement in the event of heavy winds and/or seismic activity. Personnel also need to have protections from high voltage, caustic fluids, and any other hazardous conditions associated with the operation of a battery system. There are several auxiliary systems that will also need support for operating the battery energy storage system, including secondary containment, thermal management, hydrogen management, gas diffusion electrode (GDE) support, air supply, electrolyte/water management, etc. Enclosures may be configured in accordance with various embodiments, to provide such support to one or more modules, such as modules 501-504, in a battery system.

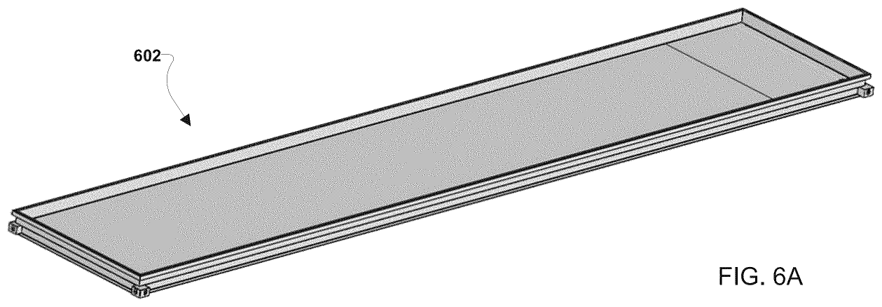

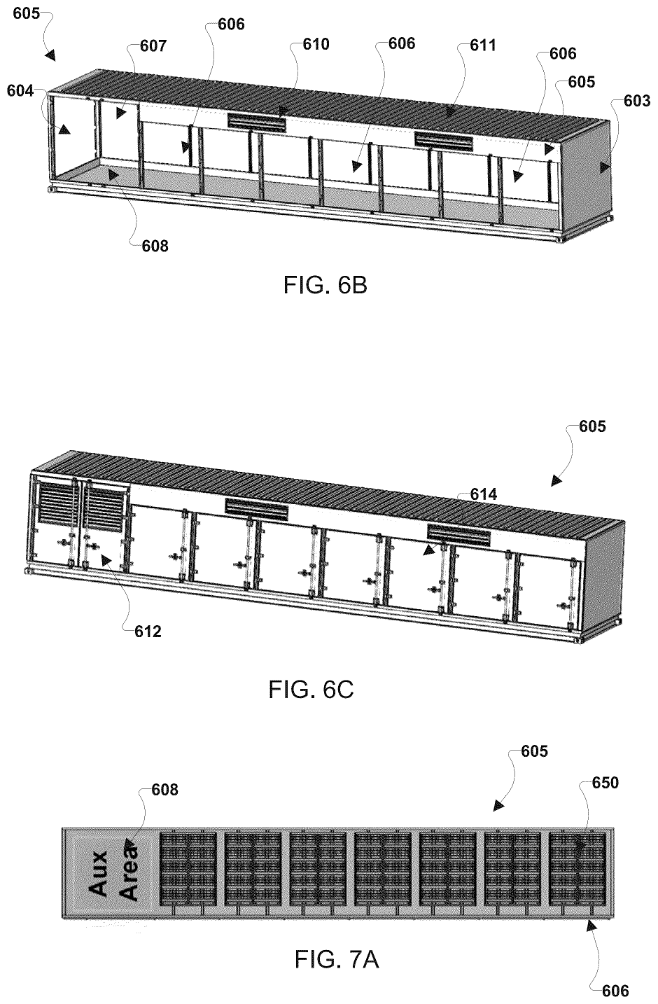

FIGS. 6A-6C illustrate portions of an example enclosure 605 for one or more modules, such as modules 501-504, in a battery system. With reference to FIGS. 1-6C, FIG. 6A illustrates a lower structure 602 of the enclosure 605, FIG. 6B illustrates the enclosure 605 with doors 612 and 614 removed, and FIG. 6C illustrates the enclosure 605 with the doors 612 and 614 installed. Additionally, other doors and/or hatches may be installed along other walls and/or the roof of the enclosure 605. In various embodiments, the lower structure 602 may support the entire weight of the battery modules for transport and installation. A secondary containment may be fabricated into the lower structure 602, for example to handle both the potential for a spill and fire water if it is incorporated in the design. Lifting points will be provided in the lower structure 602 as it can be lifted either by the corners or have additional pick points incorporated along its length. The base of the lower structure 602 may include attachment points to secure the battery modules, such as modules 501-504, to the enclosure 605, for example to support shipping, seismic event dampening, etc. In various embodiments, the enclosure 605 may include any number of modules, such as modules 501-504 therein. The configuration of the enclosure 605 illustrated in FIGS. 6A-6C shows a configuration for at least seven modules, such as modules 501-504, but more or less modules may be present in the enclosure depending on enclosure size and/or configuration. The enclosure 605 may include mounting points provided to attach to a variety of field installation structures, such as grade beams, piles, helical piers, foundations, etc., upon deployment in the field.

In some embodiments, the enclosure may include an auxiliary area 608 at one end of the enclosure in which auxiliary equipment to support the modules, such as modules 501-504, may be mounted. Auxiliary equipment may include, pumps, blowers, controllers, switches, connections, tubing, ducting, heaters, chillers, filters, reservoirs, tanks, electronics, or any other type of equipment that may support the operation of the modules, such as modules 501-504, within the enclosure 605. The support subsystems may be housed in the auxiliary area 608 and connected to the modules, such as modules 501-504. The support subsystems may include GDE air systems, thermal management systems, heating systems, hydrogen management systems, water and/or electrolyte management systems, power electronics systems, controls electronics systems, communication systems, telemetry sensors and equipment, and/or disconnects from plant level services, as well as any other type of subsystems.

The floor of the enclosure 605 may also have perforations to allow for stub ups of electrical, water, or any other desired connection to be made upon installation in the field as long as the perforation is properly designed to maintain the secondary containment requirements of the lower structure.

As illustrated in FIGS. 6B and 6C, walls 603, 604, and 607 may be attached to the lower structure 602, and designed to support any snow loads taken up by the roof 611, as well being designed to handle wind loads. This structural shell may also provide a for mounting any of the auxiliary subsystems that need to be run throughout the enclosure 605. While illustrated as walls 603, 604, and 607 and roof 611, all or portions of the walls and/or roof may be formed from other materials, such as fabric, cloth, etc. In various configurations, the enclosure may be formed into different areas, such as the auxiliary area 608 and module bays 606. In various embodiments, the auxiliary area 608 may be covered by a door 612 on one or both long sides of the enclosure 605 and module bays 606 may be covered by doors 614 on one or both long sides of the enclosure 605. The doors 612 and/or 614 may enable access to the auxiliary equipment and/or modules for servicing and/or replacement. In some embodiments, perforations 610 may be present in the walls 603, 604, 607 and/or roof 611 to allow for air to be exchanged from ambient to the enclosure 605 and vice versa. Filter grates may be one example of the perforations 610. The configuration of the enclosure 605 may maintain low dust intrusion and/or protect against driven rain.

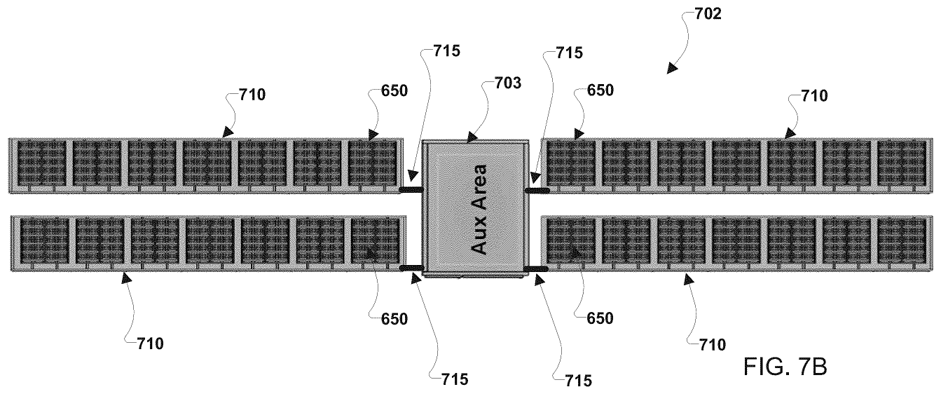

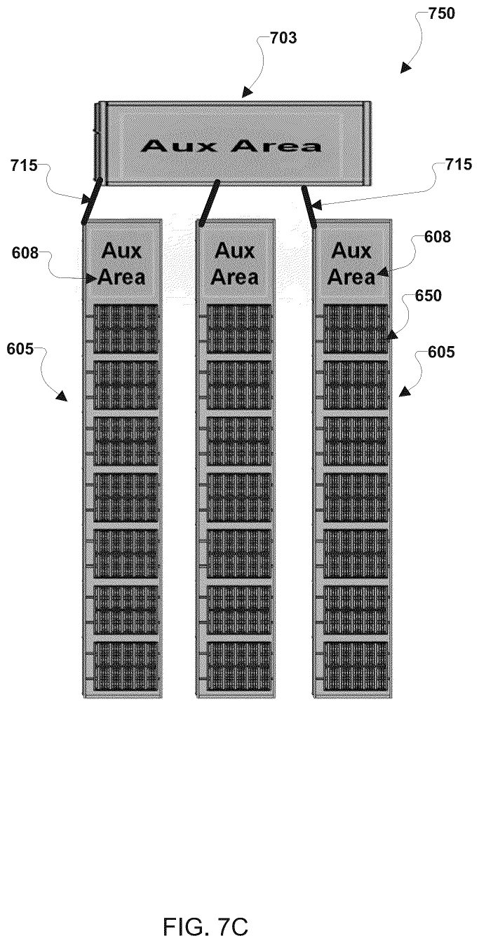

FIGS. 7A-7C illustrate battery module enclosure configurations in accordance with various embodiments. With reference to FIGS. 1-7C, FIG. 7A illustrates a top-down view of example enclosure 605 in which the auxiliary area 608 is within the enclosure 605 and co-located with the modules 650, such as modules 501-504, within the module bays 606. While seven sets of modules are illustrated in FIG. 7A, this is merely one example, and more or less modules may be present in the enclosure 605.

FIG. 7B illustrates an alternative configuration 702 in which the enclosures 710 supporting the modules 650, such as modules 501-504, may not include auxiliary areas therein, and rather a central auxiliary area 703 may support one or more enclosures 710. This separate auxiliary area 703 enclosure may be connected to the modules by one or more connections 715 and the auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the enclosures 710 and the modules 650 therein. While four enclosures 710 are illustrated in FIG. 7B, more or less enclosures 710 may be connected to the auxiliary area 703 and the auxiliary area 703 may be sized according to the number of enclosures to support and number of modules within the enclosures.

FIG. 7C illustrates an alternative configuration 750 in which a separate auxiliary area 703 enclosure is connected to the enclosures 605 which also have auxiliary areas 608 therein. In this manner, some auxiliary system functions may be in whole, or in part, offloaded to the separate auxiliary area 608 and some auxiliary system functions may in whole, or in part, remain at the enclosure 605 level.

While FIGS. 7A-7C illustrate various configurations for enclosures and/or auxiliary areas, the configurations illustrated in FIGS. 7A-7C are merely examples according to various embodiments and are not intended to be limiting. Other configurations of enclosures and/or auxiliary areas may be substituted for the example configuration of FIGS. 7A-7C and other configurations are in accordance with the various embodiments.

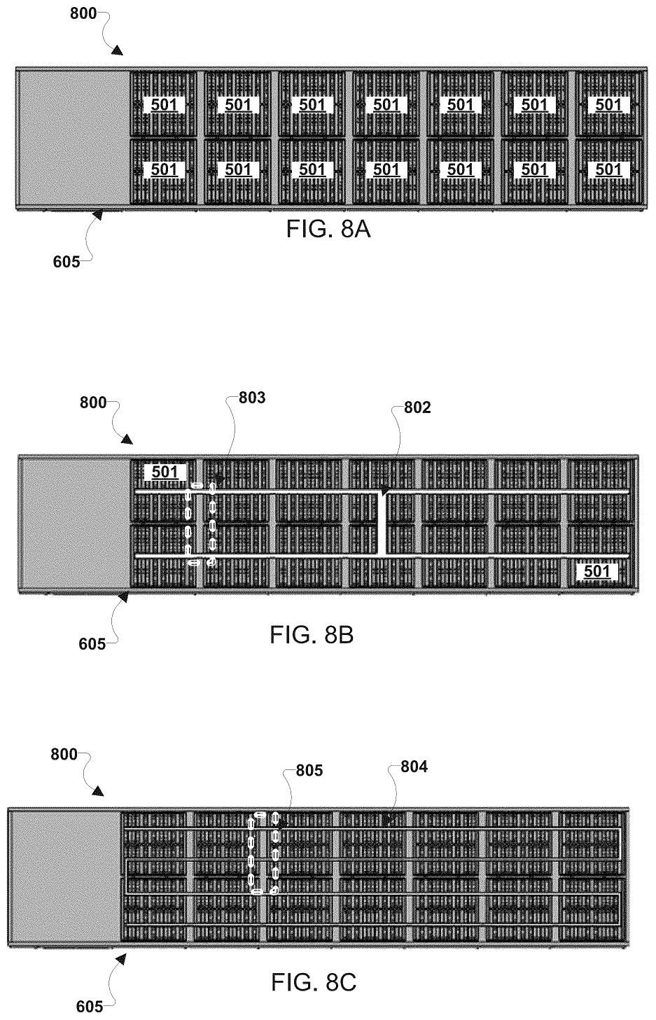

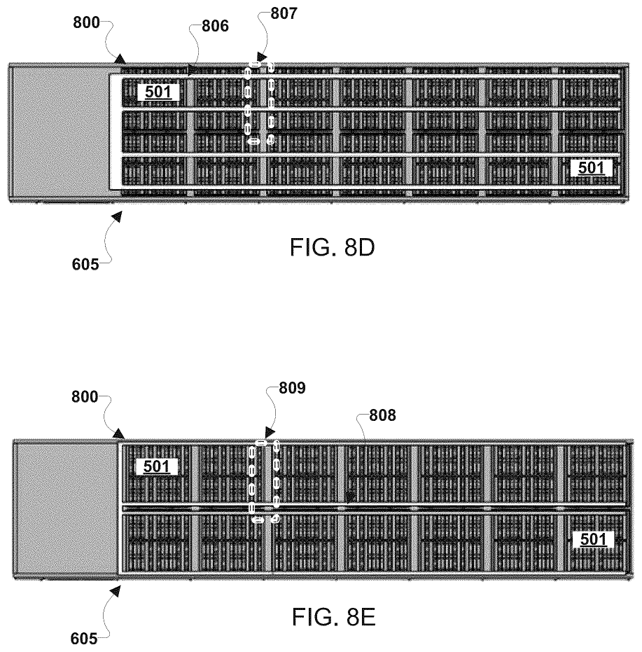

FIGS. 8A-8E illustrate an example module 501 layout 800 within an enclosure 605 in accordance with various embodiments. With reference to FIGS. 1-8E, FIGS. 8A-8E illustrate a layout 800 in which two modules 501 are arranged front to back within a module bay. In the layout 800, electrical routing may be provided, and all hookups may be on the enclosure 605 short end. In the layout 800, space may be required within the enclosure 605 for module removal. In the layout 800, electrode width may be tied to the smallest enclosure 605 dimension. In the layout 800, thermal spacing may be tied to the smallest enclosure dimension. Layout 800 may require connection and/or disconnection of a back module 501 of the two modules 501 in each module bay. Layout 800 may require some activities of personnel to be performed in the enclosure.

FIG. 8B illustrates an example thermal management ducting/plumbing system configuration 803 and connections 804 needed to be made inside the enclosure 605 to install and/or remove a module 501. FIG. 8C illustrates an example electrical system connection configuration 804 and connections 805 needed to be made inside the enclosure 605 to install and/or remove a module 501. FIG. 8D illustrates an example GDE air system connection configuration 806 and connections 807 needed to be made inside the enclosure 605 to install and/or remove a module 501. FIG. 8E illustrates an example water and/or electrolyte system connection configuration 808 and connections 809 needed to be made inside the enclosure 605 to install and/or remove a module 501.

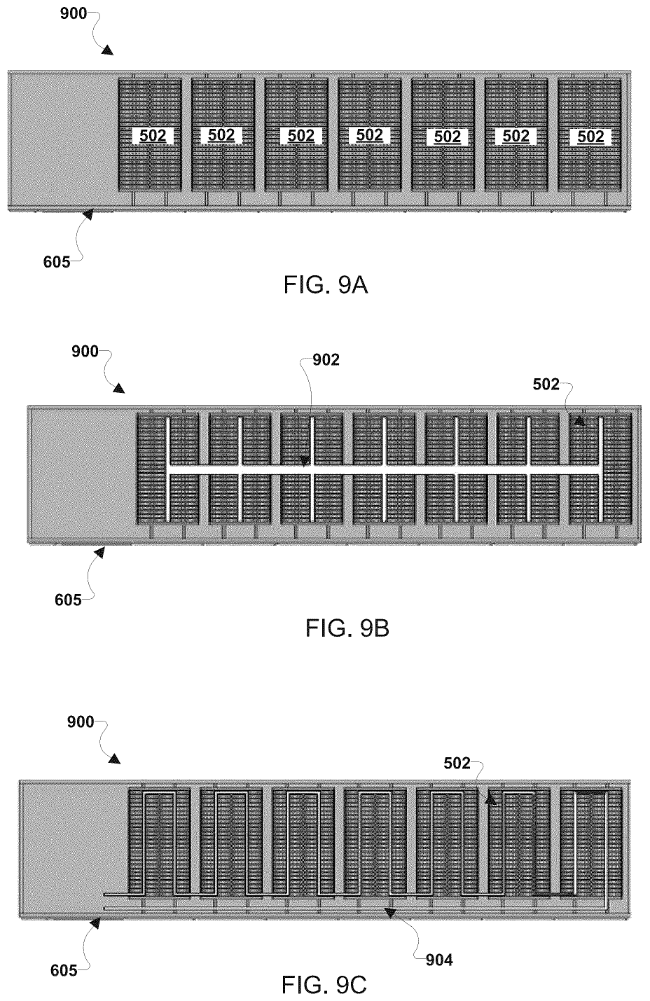

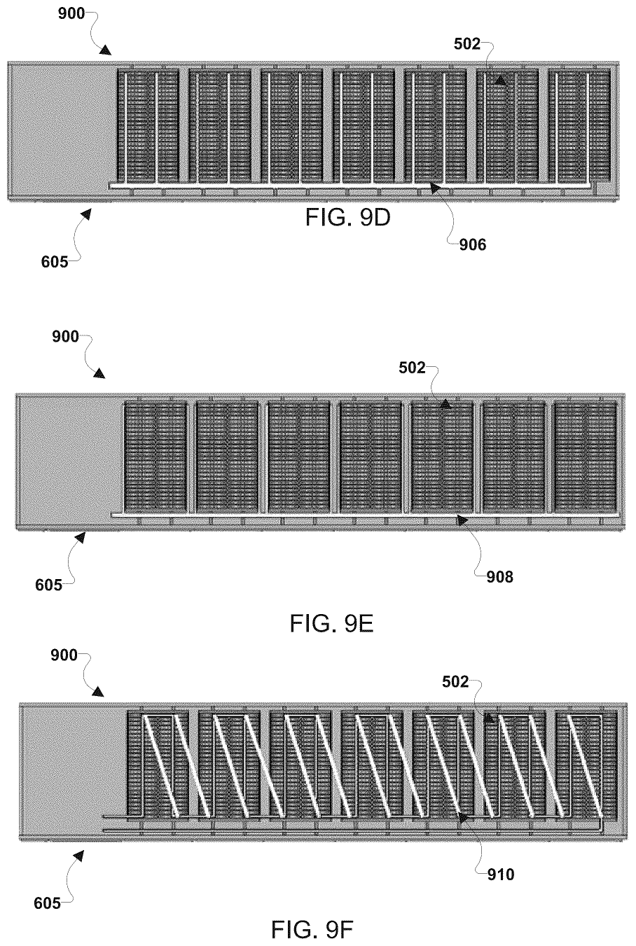

FIGS. 9A-9F illustrate an example module layout 900 within an enclosure 605 in accordance with various embodiments. With reference to FIGS. 1-9F, FIGS. 9A-9F illustrate a layout 900 in which a module 502 may be arranged within each module bay. In the layout 900, the module connections may be at the doors of the module bays.

FIG. 9B illustrates an example thermal management ducting/plumbing system configuration 902 inside the enclosure 605. FIG. 9C illustrates an example electrical system connection configuration 904 inside the enclosure 605. FIG. 9D illustrates an example GDE air system connection configuration 906 inside the enclosure 605. FIG. 9E illustrates an example water and/or electrolyte system connection configuration 908 inside the enclosure 605. FIG. 9F illustrates an optional second electrical system connection configuration 910 (shown in white) including blind mating at the back of the modules 502 and front side connections.

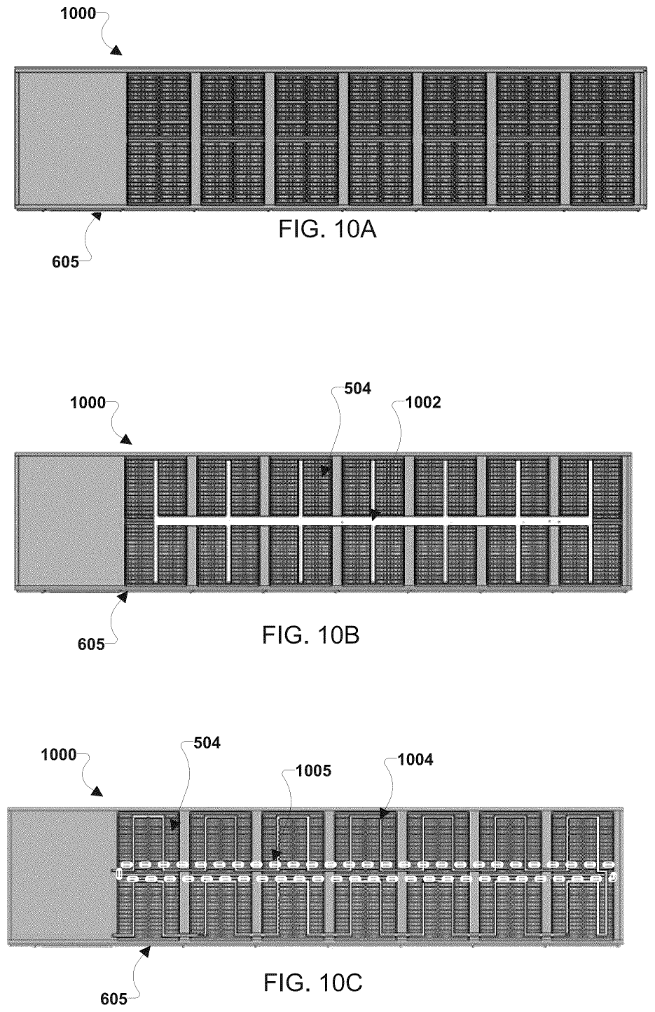

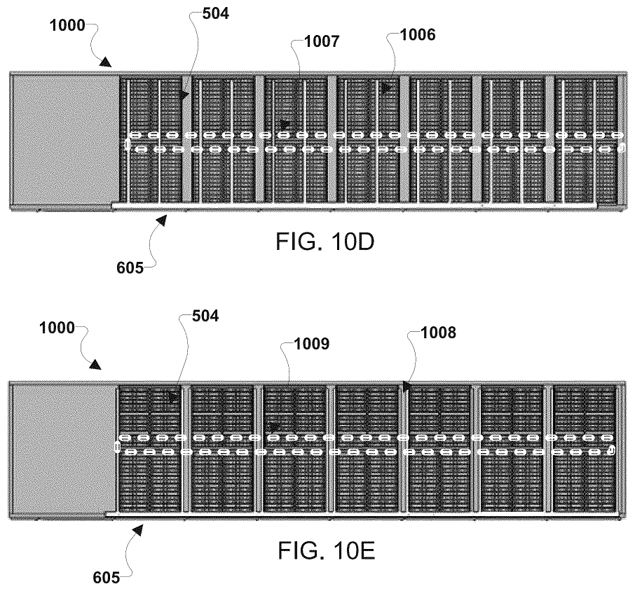

FIGS. 10A-10E illustrate an example module 504 layout 1000 within an enclosure 605 in accordance with various embodiments. With reference to FIGS. 1-10E, FIGS. 10A-10E illustrate a layout 1000 in which two modules 504 are arranged front to back within a module bay. In the layout 1000, space may be required within the enclosure 605 for module removal. In the layout 1000, electrode width may be independent of enclosure 605 width. Layout 1000 may require connection and/or disconnection of a back module 504 of the two modules 504 in each module bay. Layout 1000 may require some activities of personnel to be performed in the enclosure.

FIG. 10B illustrates an example thermal management ducting/plumbing system configuration 1003 inside the enclosure 605. FIG. 10C illustrates an example electrical system connection configuration 1004 and connections 1005 needed to be made inside the enclosure 605 to install and/or remove a module 504. FIG. 10D illustrates an example GDE air system connection configuration 1006 and connections 1007 needed to be made inside the enclosure 605 to install and/or remove a module 504. FIG. 10E illustrates an example water and/or electrolyte system connection configuration 1008 and connections 1009 needed to be made inside the enclosure 605 to install and/or remove a module 504.

While FIGS. 8A-10E illustrate various configurations for enclosures and modules within those enclosures, the configurations illustrated in FIGS. 8A-10E are merely examples according to various embodiments and are not intended to be limiting. Other configurations for enclosures and modules within those enclosures may be substituted for the example configuration of FIGS. 8A-10E and other configurations are in accordance with the various embodiments.

### Electrolyte Management

Over time, the electrolyte of metal-air batteries may lose water due to evaporation through the GDE and/or due to the hydrogen evolution reaction (HER) that occurs during charging. In addition, or in the alternative, water loss rates of different battery cells may vary due to variations in cell configuration, cell cycling temperatures, electrical flow, and air flow to cell GDEs.

Accordingly, any one or more of the systems for electrochemical power storage described herein may include electrolyte management systems that facilitate maintaining electrolyte levels by replacing lost water.

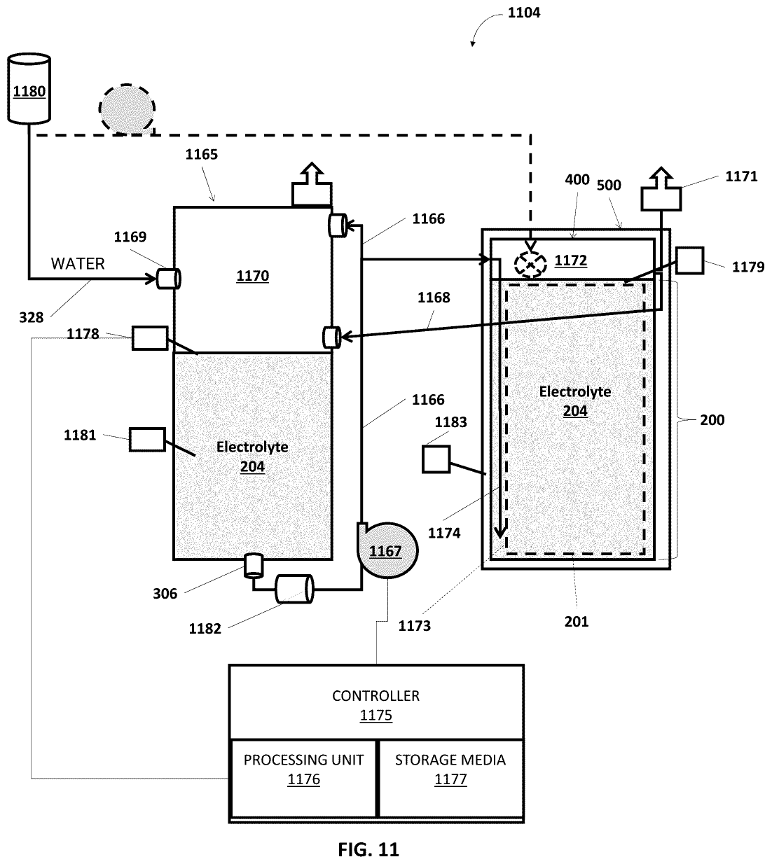

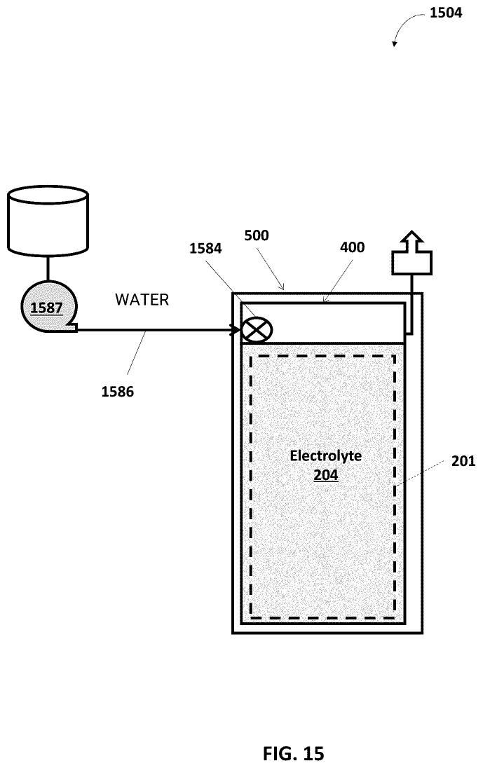

For the sake of clear and efficient description, elements numbers having the same last two digits in the disclosure that follows in relation to FIGS. 11-15 shall be understood to be analogous to or interchangeable with one another, unless otherwise explicitly stated or made clear from the context and, therefore, are not described separately from one another, except to note difference or to emphasize certain features. Further, a LODES 104 in FIG. 2 and a system 1104 for electrochemical power storage in FIG. 11 shall be understood to be analogous to or interchangeable with one another, unless otherwise specified or made clear from the context.

Referring now to FIGS. 1-11, a system 1104 for electrochemical power storage may include at least one instance of a battery module 500, a reservoir 1165, a supply conduit 1166, a pump 1167, and a return conduit 1168. Each instance of the battery module 500 may include the battery enclosure 400 and the metal-air battery 200, with the metal-air battery 200 disposed in the battery enclosure 400. The reservoir 1165 may include a volume of the liquid electrolyte 204. For example, the reservoir 1165 may store a volume of the liquid electrolyte 204, such that a reservoir headspace 1170 is formed above the volume of the liquid electrolyte 204 in the reservoir 1165. The supply conduit 1166 may be in fluid communication between the reservoir 1165 and the battery enclosure, and the pump 1167 may be actuatable to move the liquid electrolyte 204 from the reservoir 1165 into the battery enclosure 400 via the supply conduit 1166. The return conduit 1168 may be in fluid communication between the battery enclosure 400 and the reservoir, with the liquid electrolyte 204 movable from the battery enclosure 400 to the reservoir 1165, via the return conduit 1168, with the metal-air battery 200 immersed in the liquid electrolyte 204 in the battery enclosure 400. In use, the circulation of the liquid electrolyte 204 from the reservoir 1165 into the battery enclosure 400 and the return of an excess amount of the liquid electrolyte 204 from the battery enclosure 400 back to the reservoir 1165 may facilitate maintaining a level of the liquid electrolyte 204 in the battery module 500 to within a predetermined range, even as water from the liquid electrolyte 204 is lost over time due to evaporation and/or other loss modes. The reservoir 1165 may be disposed in the auxiliary areas 608 and/or 703 shown in FIGS. 7B and 7C, for example.

In certain implementations, each instance of the metal-air battery 200 may include the vessel 201, the metal electrode 202, the air electrode 203, the liquid electrolyte 204, with the metal electrode 202 and the air electrode 203 immersed in the liquid electrolyte 204 in the vessel 201 such that and a headspace region 1172 is defined between the battery enclosure 400 and the liquid electrolyte 204 in the vessel 201 in each instance of the battery module 500. The headspace region 1172 may include electrical connections that electrically connect the metal-air battery 200 to other system components, such as other instances of the metal-air battery 200, charging lines and/or discharging lines. In some instances, the battery enclosure 400 and/or the return conduit 1168 may be in fluid communication with at least one instance of a vent 1171. The at least one instance of the vent 1171 in fluid communication with the battery enclosure 400 and/or with the return conduit 1168 may relieve system pressure fluctuations and/or reduce the likelihood of vapor lock in the system 1104.

While the battery module 500 is depicted as including a single instance of the battery module 500, it shall be appreciated that this is for the sake of clear and efficient description. Unless otherwise specified or made clear from the context, the battery module 500 may house multiple instances of the battery enclosure 400. In such embodiments, it shall be understood that the supply conduit 1166 and the return conduit 324 may each be manifolds fluidly connected to each instance of the battery enclosure 400 in parallel, such as may be useful for reducing pressure drop and increasing the overall flow rate of the liquid electrolyte 204 between the reservoir 1165 and the multiple instances of the battery enclosure 400. The parallel connections may also, or instead, reduce the likelihood of over pressure, which may result in undesirable flow of the liquid electrolyte 204. In addition, or instead, parallel connections may facilitate independently draining the liquid electrolyte 204 from each instance of the battery enclosure 400, which may be useful for maintaining isolation of the respective instances of the metal-air battery 200, thus reducing the likelihood of shunt currents during charging and/or discharging. Draining the liquid electrolyte 204 independently may reduce the likelihood of an unintended fluidic connection between the instances of the metal-air battery 200 in the respective instances of the battery enclosure 400.

In certain implementations, the supply conduit 1166 may supply the liquid electrolyte 204 from the reservoir 1165 to a bottom portion 1173 of the battery enclosure 400. For example, an outlet section 1174 of the supply conduit 1166 may be coupled to the bottom portion 1173 of the vessel 201. As compared to introducing a liquid electrolyte into a headspace region, introduction of the liquid electrolyte 204 into the vessel 201 via the supply conduit 1166 coupled to the bottom portion 1173 of the vessel 201 may reduce the likelihood of splashing or other disturbance of the liquid electrolyte 204 that may increase the likelihood of shorting or other unintended operation modes.

The return conduit 1168 may drain the liquid electrolyte 204 from the battery enclosure 400 to reduce the likelihood of, or even prevent, the liquid electrolyte 204 from filling the headspace region 1172 and/or entering undesired channels and/or locations. For example, the return conduit 1168 may passively drain an excess amount of the liquid electrolyte 204 from the headspace region 1172 to the reservoir 1165. As a specific example, the return conduit 1168 may be angled between the battery enclosure 400 and the reservoir 1165 such that gravity forces the liquid electrolyte 204 through the return conduit 1168 to the reservoir 1165.

Draining the excess amount of the liquid electrolyte 204 may reduce the likelihood of unintended fluidic connections between multiple instances of the metal-air battery 200 in respective different instances of the battery enclosure 400 (e.g., through the liquid electrolyte 204 unintentionally exiting one instance of the battery enclosure 400 and entering another instance of the battery enclosure 400 while the system 1104 is in operation). Further, or instead, draining an excess amount of the liquid electrolyte 204 may reduce the likelihood of undesired fluidic connections between components within the battery enclosure 400 (e.g., such as fluidic connections cause by the liquid electrolyte 204 flowing into undesired channels and/or locations).

In certain implementations, the supply conduit 1166 may be in fluid communication with the reservoir headspace 1170. In such instances, a vent in the reservoir headspace 1170 may reduce the likelihood of vapor lock within the supply conduit 1166. configured to prevent vapor lock within the supply conduit 320. Additionally, or alternatively, an additional electrolyte and/or additives may be added to the liquid electrolyte 204 in the reservoir 1165 for performance enhancement over the lifetime of the product application.

In some embodiments, the system 1100 may include a filter 1182 in fluid communication with the supply conduit 1166. Precipitants or other impurities from the liquid electrolyte 204 moving through the supply conduit 1166 may be removable by the filter 1182 configured to remove impurities from the electrolyte 340.

In certain implementations, the system 1104 may include an inlet valve 1169 in fluid communication with a water source 1180 (e.g., a source of demineralized or deionized water). In general, the inlet valve 1169 may be actuatable to control a flow of water from the water source 1180 into the volume of the liquid electrolyte 204 in the reservoir 1165. Stated differently, the inlet valve 1169 may be actuatable to selectively add water from the water source 1180 into the volume of the liquid electrolyte 204 in the reservoir 1165 such that a predetermined lower level of the volume of the liquid electrolyte 204 in the reservoir 1165 may be maintained with the reservoir 1165.

In some implementations, the system 1104 may additionally, or alternatively, include a controller 1175 having a processing unit 1176 and non-transitory computer-readable storage media 1177 communicatively coupled with one another (e.g., via wired and/or wireless communication). As described in greater detail below, the processing unit 1176 may be in wired and/or wireless communication with one or more sensors and one or more adjustable hardware components of the system 1104, and the non-transitory computer-readable storage media 1177 may have stored thereon computer executable instructions for causing the processing unit 1176 to carry out any one or more of the various different control techniques described herein for managing the liquid electrolyte 204 in the at least one instance of the battery module 500.

For example, the system 1104 may include a level sensor 1178 arranged to detect a filling level of the volume of the liquid electrolyte 204 in the reservoir 1165. Continuing with this example, the controller 1175 (e.g., the processing unit 1176 of the controller 1175) may be communicatively coupled to the level sensor 1178 and to the pump 1167. Continuing still further with this example, the non-transitory computer readable storage of the 1177 of the controller 1175 may have stored thereon computer readable instructions for causing the processing unit 1176 to receive, from the level sensor 1178, a signal indicative of the filling level of the volume of the liquid electrolyte 204 in the reservoir 1165 and to actuate the inlet valve 1169 to control the flow of water from the water source 1180 into the volume of the electrolyte 204 in the reservoir 1165 such that the filling level of the volume of the liquid electrolyte 204 in the reservoir 1165 is maintained between in a predetermined range (e.g., between a predetermined maximum and predetermined minimum filling level). In some instances, the controller 1175 may control the pump 1167 based on additional or alternative sensors. For example, the system 1104 may include a level sensor 1179 arranged to detect a level of the liquid electrolyte 204 in the battery enclosure 500. Additionally, or alternatively, the system 1104 may include a composition sensor 1181 operable to determine a composition of the liquid electrolyte 204. In certain instances, the controller 1175 may control the speed of the pump 1167, based on an electrolyte level detected by the level sensor 1178 and/or the level sensor 1179, the electrolyte composition detected by the composition sensor 1181, and/or an operating state of the battery module 500 For example, the controller 1175 may control electrolyte dosing and/or recommend dosing materials and amounts, based on the composition data received from the composition sensor 1181. Still further, or instead, the system 1104 may include sensors, such as a current draw sensor, a pump flow rate sensor, and/or tachometer feedback sensor, to detect a current draw, flow rate, and/or speed, respectively, of the pump 1167. Additionally, or alternatively, based on one or more signals from any one or more of the sensors described herein, the controller 1175 may provide pulse with modulation (PWM) or variable frequency drive (VFD) control of the pump 1167.

In certain instances, the system 1104 may include a sensor 1183 arranged to detect overflow of the liquid electrolyte 204 from the vessel 201. The controller 1175 (e.g., the processing unit 1176 of the controller 1175) may communicatively coupled to the sensor 1183 and to the pump 1167. Continuing with this example, the non-transitory computer readable storage of the 1177 of the controller 1175 may have stored thereon computer readable instructions for causing the processing unit 1176 to receive, from the sensor 1183, a signal indicative of the liquid electrolyte 204 overflowing the vessel 201 and to control actuation of the pump 1167, based on the signal from the sensor 1183, such that the pump 1167 fills the vessel 201 with the liquid electrolyte 204 until the liquid electrolyte 204 overflows the vessel 201, enters the return conduit 1168, and returns to the reservoir 1165.

In some embodiments, the system 1104 may heat the liquid electrolyte 204 and/or the metal-air battery 200 using an integrated heater. In some embodiments, the system 1104 may drain the liquid electrolyte 204 from individual instances of the battery enclosure 400.

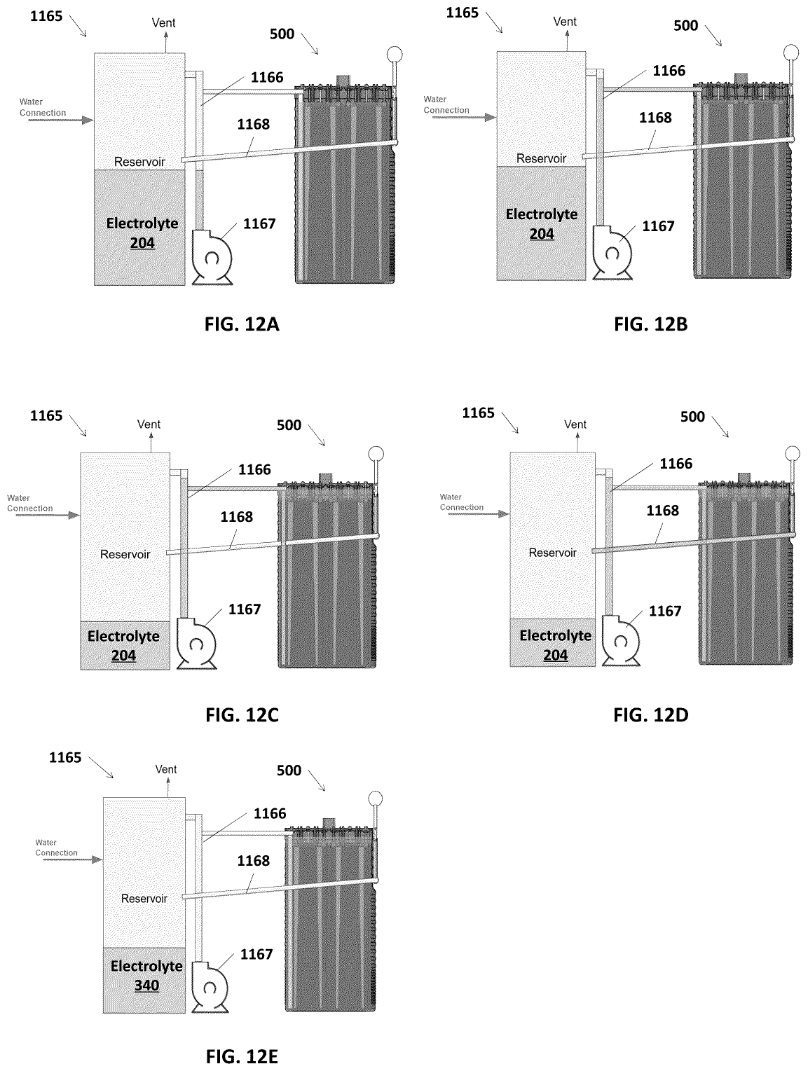

FIGS. 12A-12E are schematic representations of a time-varying sequence of operation electrolyte management in the system 1104 for electrochemical power storage.

Referring to FIG. 12A, the metal-air battery 200 of the battery module 500 may be inactive and the reservoir 1165 may be filled with the liquid electrolyte 204.

Referring to FIG. 12B, the pump 1167 may be activated to pump the liquid electrolyte 204 from the reservoir 1165 to the battery module 500.

Referring to FIG. 12C, the filling of the liquid electrolyte 340 may continue until each instance of the metal-air battery 200 is completely filled.

Referring to FIG. 12D, at the filling limit, electrodes of the metal-air battery 200 of each battery module 500 are completely immersed in the liquid electrolyte 204 and an excess amount of the liquid electrolyte 204 may overflow and drains back into the reservoir 1165 via the return conduit 1168.

As shown in FIG. 12E, once electrolyte filling is complete, the pump 1167 may be turned off and any amount of the liquid electrolyte 204 remaining in the return conduit 1168 may flow into the reservoir 1165.

Referring now to FIGS. 1-10E and FIG. 13, a system 1304 for electrochemical power storage may include the battery module 500, a reservoir 1365, a transfer conduit 1388, and a plunger 1389. The reservoir 1365 include a volume of the liquid electrolyte 204, and the reservoir 1365 may be in fluid communication with the battery enclosure 400 via the transfer conduit 1388. The plunger 1389 may be disposed in the reservoir 1365 and movable in the reservoir 1365 to control a flow of the liquid electrolyte between the battery enclosure 400 and the reservoir 1365 via the transfer conduit 1388. For example, the plunger 1389 may be movable between a raised position and a lower position to control the flow of the liquid electrolyte 204 between the battery enclosure 400 and the reservoir 1365 via the transfer conduit 1388. For example, the plunger 1389 in the raised position may move an excess amount of the liquid electrolyte 204 from the battery enclosure 400, through the transfer conduit 1388, and into the reservoir 1365. Further, or instead, the plunger 1389 in the lowered position may force the liquid electrolyte 204 in the reservoir 1365 through the transfer conduit 1388 and into the battery enclosure 400.

In certain implementations, the reservoir 1365 may define an opening 1390. The reservoir 1365 may be in fluid communication with the transfer conduit 1388 through the opening 1390. The plunger 1389 in the raised position may be disposed above the opening 1390 such that an excess amount of the liquid electrolyte 204 may flow in a direction from the battery module 500 and into the reservoir 1365 via the transfer conduit 1388. Further, or instead, the plunger 1389 in the lowered position may be disposed below the opening 1390 such that the liquid electrolyte 204 in the reservoir is forced out of the opening 1390, through the transfer conduit 138, and into the battery module 500.

In some instances, the system 1304 may include an inlet valve 1391 actuatable to control a flow of water from a water source 1380 into the volume of the liquid electrolyte 204 in the reservoir 1365. For example, when the plunger 1389 is in the raised position, water received from the water source 1380 may be collected below the plunger 189 and, when the plunger 1389 is in the lowered position, the water and/or the liquid electrolyte 204 are forced from the reservoir 1365 and into the battery enclosure 400.

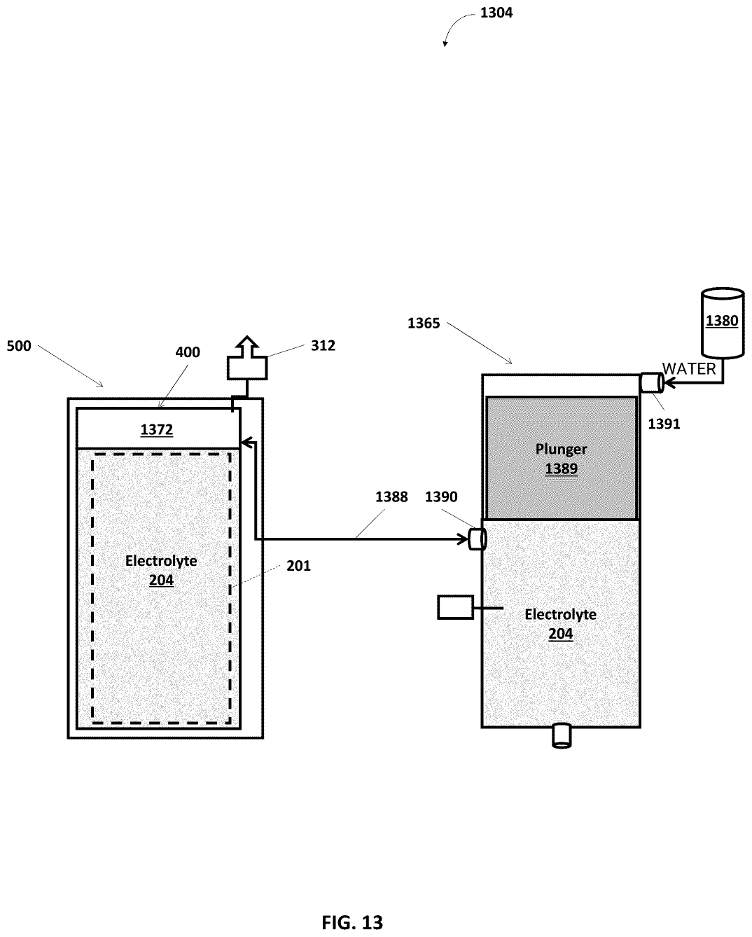

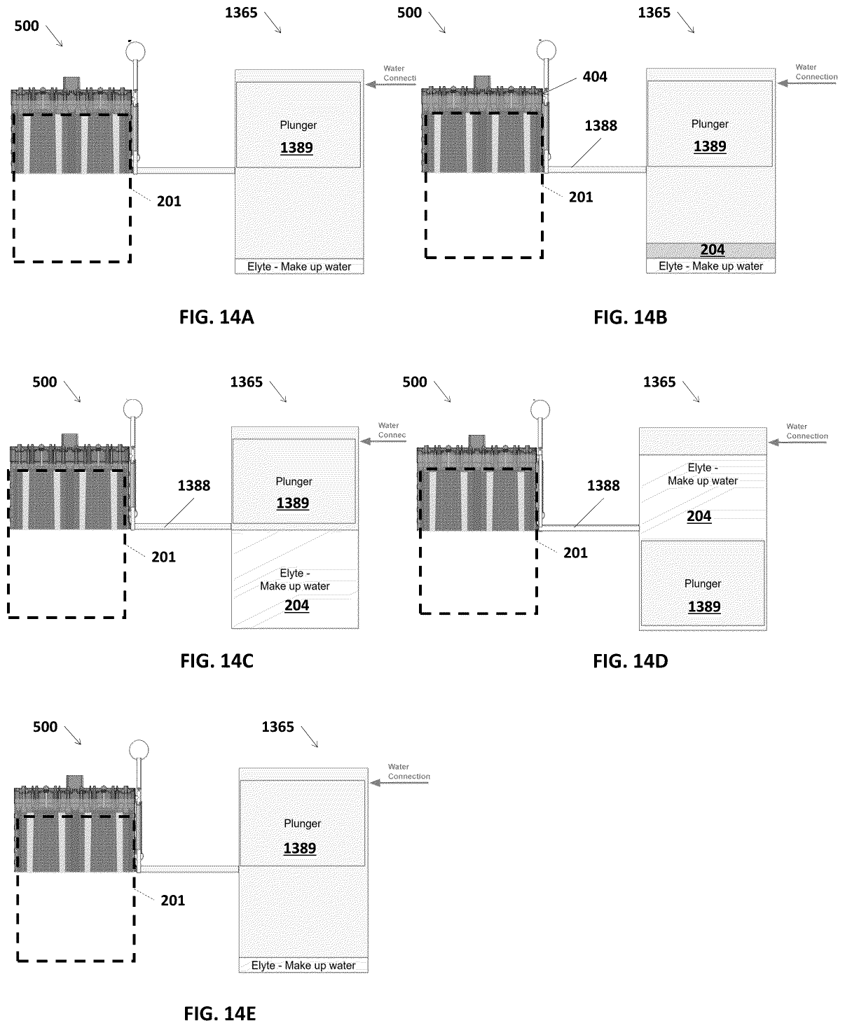

FIGS. 14A-14E are schematic representations of a time-varying sequence of operations of the electrolyte management system of FIG. 13.

Referring to FIGS. 13 and 14A, the plunger 1389 may be disposed in the raised position and the electrodes of the metal-air battery 200 of each instance of the battery module 500 may be submerged in the liquid electrolyte 204. Makeup water may be present in the bottom of the reservoir 1365.

As shown in FIG. 14B, charging of the metal-air battery 200 may cause the liquid electrolyte 204 to swell and enter a headspace region 1372, and the excess amount of the liquid electrolyte 204 may flow into the reservoir 1365 via the transfer conduit 1388.

As shown in FIG. 14C, additional water may be added to the liquid electrolyte 204 to restore electrolyte volume losses due to evaporation through the GDE and/or the HER.

As shown in FIG. 14D, the plunger 1389 may be moved to the lowered position, such that the liquid electrolyte 204 is displaced and forced higher into the reservoir 1365. As a result, the liquid electrolyte 204 may be pushed through the transfer conduit 1388 and refill the battery enclosure 400.

As shown in FIG. 14E, the plunger 1389 be returned to the raised position, allowing an excess amount of the electrolyte 204 to flow back into the reservoir 1365 for cell isolation.

Referring now to FIGS. 1-10E and FIG. 15, a system 1504 for electrochemical power storage may include at least one instance of the battery module 500, a water conduit 1586 (which may be a manifold), and at least one instance of a float valve 1584. The float valve 1184 may be disposed in the battery enclosure 400. The float valve 1184 may be actuatable, according to a level (e.g., a predetermined level) of the liquid electrolyte 204 in the battery enclosure 400 to control a flow of water from the water source 1180 into the respective instance of the battery enclosure 400. For example, a water conduit 1186 may be a manifold fluidically connecting each instance of the float valve 1184 to the water source 1180 and to a water pump 1187 such that the water pump 1187 may move water from the water source 1180 to each instance of the battery enclosure 400 via the water conduit 1186. The water conduit 1186 may connect a plurality of instances of the float valve 1184 to the water source 1180 in parallel or in series. The water pump 1587 may generate a minimum line pressure of at least 20 psi. A reduction of the level of the liquid electrolyte 204 in a given instance of the battery enclosure 400 may open the corresponding instance of the float valve 1184, allowing water to flow into the corresponding instance of the battery enclosure 400. An increase in the level of the liquid electrolyte 340 in the battery enclosure 400 may move the float valve 1184 to a closed position restricting ingress of water into the respective instance of the battery enclosure 400.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A system for electrochemical power storage, the system comprising:
at least one instance of a battery module, each instance of the battery module including a battery enclosure and a metal-air battery, the metal-air battery disposed in the battery enclosure;
a reservoir including a volume of a liquid electrolyte;
a supply conduit in fluid communication between the reservoir and the battery enclosure;
a pump actuatable to move the liquid electrolyte from the reservoir into the battery enclosure via the supply conduit; and
a return conduit in fluid communication between the battery enclosure and the reservoir, the liquid electrolyte movable from the battery enclosure to the reservoir, via the return conduit, with the metal-air battery immersed in the liquid electrolyte in the battery enclosure.

2. The system of claim 1, wherein each instance of the metal-air battery includes a metal electrode, and the air electrode, and a vessel, the metal electrode and the air electrode are immersed in the liquid electrolyte in the vessel, and a headspace region is defined between the battery enclosure and the liquid electrolyte in the vessel in each instance of the battery module.

3. The system of claim 2, wherein an excess amount of the liquid electrolyte passively drains from the headspace region to the reservoir via the return conduit.

4. The system of claim 3, wherein the return conduit is angled between the battery enclosure and the reservoir such that gravity forces the liquid electrolyte through the return conduit to the reservoir.

5. The system of claim 2, wherein an outlet section of the supply conduit is coupled to a bottom portion of the vessel.

6. The system of claim 2, further comprising a controller and a sensor, the sensor arranged to detect overflow of the liquid electrolyte from the vessel, the controller communicatively coupled to the sensor and the pump, and the controller configured to receive, from the sensor, a signal indicative of the liquid electrolyte overflowing the vessel and to control actuation of the pump, based on the signal from the sensor, such that the pump fills the vessel with the electrolyte until the liquid electrolyte overflows the vessel, enters the return conduit, and returns to the reservoir.

7. The system of claim 1, wherein each instance of the battery module further includes a float valve disposed in the battery enclosure, and the float valve is actuatable, according to a level of the liquid electrolyte in the battery enclosure, to control a flow of water from a water source into the respective instance of the battery enclosure.

8. The system of claim 1, further comprising an inlet valve actuatable to control a flow of water from a water source into the volume of the electrolyte in the reservoir.

9. The system of claim 8, further comprising a level sensor arranged to detect a filling level of the volume of the liquid electrolyte in the reservoir; and
a controller communicatively coupled to the level sensor and the inlet valve, the controller configured to receive, from the level sensor, a signal indicative of the filling level of the volume of the liquid electrolyte in the reservoir and to actuate the inlet valve to control the flow of water from the water source into the volume of the liquid electrolyte in the reservoir such that the filling level of the volume of the liquid electrolyte in the reservoir is maintained between a maximum and minimum filling level.

10. The system of claim 1, further comprising a vent conduit in fluid communication with the supply conduit, wherein gas is releasable from the supply conduit via the vent conduit.

11. The system of claim 1, further comprising a filter in fluid communication with the supply conduit, wherein precipitants from the liquid electrolyte moving through the supply conduit are removable by the filter.

12. The system of claim 1, wherein, in each instance of the battery module, the metal-air battery includes an iron-air type battery cell, zinc-air type battery cell, a lithium-air battery cell, or a combination thereof.

13. The system of claim 1, wherein
the at least one instance of the battery module includes a plurality of instances of the battery module,
the supply conduit comprises a supply manifold in fluid communication, in parallel, with the reservoir and each instance of the battery enclosure, and
the return conduit includes a return manifold in fluid communication, in parallel, with the reservoir and each instance of the battery enclosure.

14. The system of claim 13, further comprising a controller communicatively coupled to the pump, wherein the controller is configured to actuate the pump to move the liquid electrolyte through the supply manifold until the respective vessel of each of the plurality of instances of the battery modules is filled with the liquid electrolyte to a predetermined level.

15. The system of claim 14, wherein an excess amount of the liquid electrolyte is drainable from the respective battery enclosure of each one of the plurality of instances of the battery module via the return manifold.

16. A system for electrochemical power storage, the system comprising:
a battery module including a battery enclosure and a metal-air battery, the metal-air battery disposed in the battery enclosure;
a reservoir comprising a volume of a liquid electrolyte;
a transfer conduit, the reservoir in fluid communication with the battery enclosure via the transfer conduit; and
a plunger disposed in the reservoir and movable in the reservoir to control a flow of the liquid electrolyte between the battery enclosure and the reservoir via the transfer conduit.

17. The system of claim 16, wherein the plunger is movable between a raised position and a lowered position to control the flow of the liquid electrolyte between the battery enclosure and the reservoir via the transfer conduit, the plunger in the raised position moves an excess amount of the liquid electrolyte from the battery enclosure, through the transfer conduit, and into the reservoir, and
the plunger in the lowered position forces the liquid electrolyte in the reservoir through the transfer conduit and into the battery enclosure.

18. The system of claim 17, wherein, the reservoir defines an opening, the reservoir is in fluid communication with the transfer conduit through the opening, the plunger in the raised position is disposed above the opening such that an excess amount of the liquid electrolyte flows in a direction from the battery module and into the reservoir via the transfer conduit, and the plunger in the lowered position is disposed below the opening such that the liquid electrolyte in the reservoir is forced out of the opening, through the transfer conduit, and into the battery module.

19. The system of claim 18, further comprising an inlet valve actuatable to control a flow of water from a water source into the volume of the liquid electrolyte in the reservoir.

20. The system of claim 19, wherein
when the plunger is in the raised position, water received from the water source is collected below the plunger, and
when the plunger is in the lowered position, the water and the liquid electrolyte is forced from the reservoir and into the battery enclosure.

21. A system for electrochemical power storage, the system comprising:
a plurality of instances of a battery module, each instance of the battery module including a battery enclosure and a metal-air battery, the metal-air battery disposed in the battery enclosure;
a water manifold fluidly in fluid communication with each instance of the battery enclosure; and
a plurality of instances of a float valve, each instance of the float valve disposed in a respective instance of the battery enclosure, and each instance of the float valve actuatable, according to a level of a liquid electrolyte in the battery enclosure, to control a flow of water from a water source, through the water manifold, and into the respective instance of the battery enclosure.
